SEQUENCE LISTING (31 sequences)

SEQ ID NO: 1 - protein, 740 aa, Thermoascus aurantiacus
  mat_peptide (1)..(740)
MRAIGLLPGIIGIAGAACPYMTGELPRSFAENPHAINRRAEGGGGAAAETEKFLSQFYLNDNDTFMTTDVGGPIEDQNSLSAGDRGPTLLEDFILRQKIQRFDHERVPERAVHARGAGAHGVFTSYADWSNITAASFLSAAGKETPVFVRFSTVAGSRGSADTARDVHGFATRFYTDEGNFDIVGNNIPVFFIQDAIQFPDLIHAVKPSPNNEIPQAATAHDSAWDFFSQQPSSLHTLFWAMAGHGIPRSYRNMDGFGIHTFRFVTDDGASKLVKFHWTSLQGKASLVWEEAQAVAGKNADYHRQDLWDAIEAGRYPEWELGVQIMDEEDQLRFGFDLLDPTKIVPEEYVPITKLGKMQLNRNPLNYFAETEQIMFQPGHVVRGIDFTEDPLLQGRLFSYLDTQLNRHGGPNFEQIPINRPRTPIHNNNRDGAAQMYIPLNKAAYTPNTLNNGSPKQANQTVGKGFFTTPGRTASGRLVRAVSSTFADVWSQPRLFYNSLVPAEQQFLINAIRFETAHITSDVVKNNVIIQLNRVSNNLAKRVARAIGVAEPEPDPTLYHNNKTANVGVFGKPLARLDGLQVGVLATVNKPDSIKQAASLKASFAADNVDVKVVAERLADGVDETYSAADAVNFDAILVANGAEGLFARDSFTARPANSTTATLYPAGRPLQILVDGFRYGKPVGALGSGAKALDAAEISTTRAGVYVANSTTDSFINGVRDGLRTFKFLDRFAIDEDAE

SEQ ID NO: 2 - protein, 729 aa, Thermoascus aurantiacus
  PEPTIDE (1)..(729)
ACPYMTGELPRSFAENPHAINRRAEGGGGAAAETEKFLSQFYLNDNDTFMTTDVGGPIEDQNSLSAGDRGPTLLEDFILRQKIQRFDHERVPERAVHARGAGAHGVFTSYADWSNITAASFLSAAGKETPVFVRFSTVAGSRGSADTARDVHGFATRFYTDEGNFDIVGNNIPVFFIQDAIQFPDLIHAVKPSPNNEIPQAATAHDSAWDFFSQQPSSLHTLFWAMAGHGIPRSYRNMAGFGIHTFRFVTDDGASKLVKFHWTSLQGKASLVWEEAQAVAGKNADYHRQDLWDAIEAGRYPEWELGVQIMDEEDQLRFGFDLLDPTKIVPEEYVPITKLGKMQLNRNPLNYFAETEQIMFQPGHVVRGIDFTEDPLLQGRLFSYLDTQLNRHGGPNFEQIPINRPRTPIHNNNRDGAAQMYIPLNKAAYTPNTLNNGSPKQANQTVGKGFFTTPGRTASGRLVRAVSSTFADVWSQPRLFYNSLVPAEQQFLINAIRFETAHITSDVVKNNVIIQLNRVSNNLAKRVARAIGVAEPEPDPTLYHNNKTANVGVFGKPLARLDGLQVGVLATVNKPDSIKQAASLKASFAADNVDVKVVAERLADGVDETYSAADAVNFDAILVANGAEGLFARDSFTARPANSTTATLYPAGRPLQILVDGFRYGKPVGALGSGAKALDAAEISTTRAGVYVANSTTDSFINGVRDGLRTFKFLDRFAIDEDAETSHHH

SEQ ID NO: 3 - protein, 729 aa, Thermoascus aurantiacus
  PEPTIDE (1)..(729)
ACPYMTGELPRSFAENPHAINRRAEGGGGAAAETEKFLSQFYLNDNDTFMTTDVGGPIEDQNSLSAGDRGPTLLEDFILRQKIQRFDHERVPERAVAARGAGAHGVFTSYADWSNITAASFLSAAGKETPVFVRFSTVAGSRGSADTARDVHGFATRFYTDEGNFDIVGANIPVFFIQDAIQFPDLIHAVKPSPNNEIPQAATAHDSAWDFFSQQPSSLHTLFWAMAGHGIPRSYRNMDGFGIHTFRFVTDDGASKLVKFHWTSLQGKASLVWEEAQAVAGKNADYHRQDLWDAIEAGRYPEWELGVQIMDEEDQLRFGFDLLDPTKIVPEEYVPITKLGKMQLNRNPLNYFAETEQIMFQPGHVVRGIDFTEDPLLQGRLFSYLDTQLNRHGGPNFEQIPINRPRTPIHNNNRDGAAQMYIPLNKAAYTPNTLNNGSPKQANQTVGKGFFTTPGRTASGRLVRAVSSTFADVWSQPRLFYNSLVPAEQQFLINAIRFETAHITSDVVKNNVIIQLNRVSNNLAKRVARAIGVAEPEPDPTLYHNNKTANVGVFGKPLARLDGLQVGVLATVNKPDSIKQAASLKASFAADNVDVKVVAERLADGVDETYSAADAVNFDAILVANGAEGLFARDSFTARPANSTTATLYPAGRPLQILVDGFRYGKPVGALGSGAKALDAAEISTTRAGVYVANSTTDSFINGVRDGLRTFKFLDRFAIDEDAETSHHH

SEQ ID NO: 4 - protein, 729 aa, Thermoascus aurantiacus
  PEPTIDE (1)..(729)
ACPYMTGELPRSFAENPHAINRRAEGGGGAAAETEKFLSQFYLNDNDTFMTTDVGGPIEDQNSLSAGDRGPTLLEDFILRQKIQRFDHERVPERAVAARGAGAHGVFTSYADWSNITAASFLSAAGKETPVFVRFSTVAGSRGSADTARDVHGFATRFYTDEGNFDIVGNNIPVFFIQDAIQFPDLIHAVKPSPNNEIPQAATAHDSAWDFFSQQPSSLHTLFWAMAGHGIPRSYRNMDGFGIHTFRFVTDDGASKLVKFHWTSLQGKASLVWEEAQAVAGKNADYHRQDLWDAIEAGRYPEWELGVQIMDEEDQLRFGFDLLDPTKIVPEEYVPITKLGKMQLNRNPLNYFAETEQIMFQPGHVVRGIDFTEDPLLQGRLFSYLDTQLNRHGGPNFEQIPINRPRTPIHNNNRDGAAQMYIPLNKAAYTPNTLNNGSPKQANQTVGKGFFTTPGRTASGRLVRAVSSTFADVWSQPRLFYNSLVPAEQQFLINAIRFETAHITSDVVKNNVIIQLNRVSNNLAKRVARAIGVAEPEPDPTLYHNNKTANVGVFGKPLARLDGLQVGVLATVNKPDSIKQAASLKASFAADNVDVKVVAERLADGVDETYSAADAVNFDAILVANGAEGLFARDSFTARPANSTTATLYPAGRPLQILVDGFRYGKPVGALGSGAKALDAAEISTTRAGVYVANSTTDSFINGVRDGLRTFKFLDRFAIDEDAETSHHH

SEQ ID NO: 5 - protein, 729 aa, Thermoascus aurantiacus
  PEPTIDE (1)..(729)
ACPYMTGELPRSFAENPHAINRRAEGGGGAAAETEKFLSQFYLNDNDTFMTTDVGGPIEDQNSLSAGDRGPTLLEDFILRQKIQRFDHERVPERAVHARGAGAHGVFTSYADWSNITAASFLSAAGKETPVFVRFSTVAGSRGSADTARDVHGFATRFYTDEGNFDIVGANIPVFFIQDAIQFPDLIHAVKPSPNNEIPQAATAHDSAWDFFSQQPSSLHTLFWAMAGHGIPRSYRNMDGFGIHTFRFVTDDGASKLVKFHWTSLQGKASLVWEEAQAVAGKNADYHRQDLWDAIEAGRYPEWELGVQIMDEEDQLRFGFDLLDPTKIVPEEYVPITKLGKMQLNRNPLNYFAETEQIMFQPGHVVRGIDFTEDPLLQGRLFSYLDTQLNRHGGPNFEQIPINRPRTPIHNNNRDGAAQMYIPLNKAAYTPNTLNNGSPKQANQTVGKGFFTTPGRTASGRLVRAVSSTFADVWSQPRLFYNSLVPAEQQFLINAIRFETAHITSDVVKNNVIIQLNRVSNNLAKRVARAIGVAEPEPDPTLYHNNKTANVGVFGKPLARLDGLQVGVLATVNKPDSIKQAASLKASFAADNVDVKVVAERLADGVDETYSAADAVNFDAILVANGAEGLFARDSFTARPANSTTATLYPAGRPLQILVDGFRYGKPVGALGSGAKALDAAEISTTRAGVYVANSTTDSFINGVRDGLRTFKFLDRFAIDEDAETSHHH

SEQ ID NO: 6 - protein, 729 aa, Thermoascus aurantiacus
  PEPTIDE (1)..(729)
ACPYMTGELPRSFAENPHAINRRAEGGGGAAAETEKFLSQFYLNDNDTFMTTDVGGPIEDQNSLSAGDRGPTLLEDFILRQKIQRFDHERVPERAVHARGAGAHGVFTSYADWSNITAASFLSAAGKETPVFVRFSTVAGSRGSADTARDVHGFATRFYTDEGNFDIVGNNIPVFFIQDAIQFPDLIHAVKPSPNNEIPQAATAHDSAWDFFSQQPSSLHTLFWAMAGHGIPRSYRNMDGFGIHTFRFVTDDGASKLVKFHWTSLQGKASLVWEEAQAVAGKNADYHRQDLWDAIEAGRYPEWELGVQIMDEEDQLRFGFDLLDPTKIVPEEYVPITKLGKMQLNRNPLNYFAETEQIMFQPGHVVRGIDFTEDPLLQGRLFSYLDTQLNRHGGPNFEQIPINRPRTPIHNNNRDGAAQMYIPLNKAAYTPNTLNNGSPKQANQTVGKGFFTTPGRTASGRLVRAVSSTFADVWSQPRLFYNSLVPAEQQFLINAIRFETAHITSDVVKNNVIIQLNRVSNNLAKRVARAIGVAEPEPDPTLYHNNKTANVGVFGKPLARLDGLQVGVLATVNKPDSIKQAASLKASFAADNVDVKVVAERLADGVDETYSAADAVNFDAILVANGAEGLFARDSFTARPANSTTATLYPAGRPLQILVDGFRYGKPVGALGSGAKALDAAEISTTRAGVYVANSTTDSFINGVRDGLRTFKFLDRFAIDEDAETSHHH

SEQ ID NO: 7 - protein, 712 aa, Aspergillus niger
  mat_peptide (1)..(712)
PYLSGEMSFTQEQDNAGDTIEVTEQTIDNTLYVNDTGSYMTTDFGTPISDQYSLKAGRRGPTLLEDFIFRQKLQRFDHERVPERVVHARGAGAYGTFKSYADWSNVTAADFLSANEKETPMFCRFSTVVGFRGSVDTARDVHGHACRFYTDEGNYDIVGINFAPFFIQDAIQFPDLVHAIKPMPNNEIPQAATAHTSAWDFFSQQSTALHSALWLMSGNGIPRSFRHMNGYGVHSFRFVAANGTSKVVRYRWKSQQGVASLVWEEAQAAAGKNSDYHRQDLYNAIANGHYPKYELQAQIMDEADMLRFGFDLLDPTKLVPEEVVPYTPLGMMELNANPTNYFAEVEQAGFQPGHVVPGIDFTDDPLLQGRLFSYLDTQLTRHGGPNFEQIPVNRPRKPVHNNNRDGFGQQQIPTNNWAYTPNTMSNGYPMQANQTHGHGFFTSPYRYASGHLIREPSPTFHDHWSQPAMFWNSLIPAEQQMVVNAIVFENSKVNSPHVRKNVVNQLNMVNNNLAVRVARGLGLDEPSPNPTYYTSNKTSNVGTFGKPLLSIEGLQVGFLASNSHPESIKQGQAMAAQFSAAGVDLNIVTEAYADGVNTTYALSDAIDFDALIIADGVQSLFASPSLANQMNSTATSTLYPPARPYQILVDSFRYGKPVAAVGSGSAALKNAGIDTSRSGVYTGSSETTENIAKEVLKGLYTFRFVDRFALDE

SEQ ID NO: 8 - protein, 730 aa, Aspergillus niger
  mat_peptide (1)..(730)
MRHFWLLPAVAGIAGAQCPYLSGEMSFTQEQDNAGDTIEVTEQTIDNTLYVNDTGSYMTTDFGTPISDQYSLKAGRRGPTLLEDFIFRQKLQRFDHERVPERVVHARGAGAYGTFKSYADWSNVTAADFLSANEKETPMFCRFSTVVGFRGSVDTARDVHGHACRFYTDEGNYDIVGINFAPFFIQDAIQFPDLVHAIKPMPNNEIPQAATAHTSAWDFFSQQSTALHSALWLMSGNGIPRSFRHMNGYGVHSFRFVAANGTSKVVRYRWKSQQGVASLVWEEAQAAAGKNSDYHRQDLYNAIANGHYPKYELQAQIMDEADMLRFGFDLLDPTKLVPEEVVPYTPLGMMELNANPTNYFAEVEQAGFQPGHVVPGIDFTDDPLLQGRLFSYLDTQLTRHGGPNFEQIPVNRPRKPVHNNNRDGFGQQQIPTNNWAYTPNTMSNGYPMQANQTHGHGFFTSPYRYASGHLIREPSPTFHDHWSQPAMFWNSLIPAEQQMVVNAIVFENSKVNSPHVRKNVVNQLNMVNNNLAVRVARGLGLDEPSPNPTYYTSNKTSNVGTFGKPLLSIEGLQVGFLASNSHPESIKQGQAMAAQFSAAGVDLNIVTEAYADGVNTTYALSDAIDFDALIIADGVQSLFASPSLANQMNSTATSTLYPPARPYQILVDSFRYGKPVAAVGSGSAALKNAGIDTSRSGVYTGSSETTENIAKEVLKGLYTFRFVDRFALDE

SEQ ID NO: 9 - protein, 713 aa, Aspergillus lentulus
  mat_peptide (1)..(713)
VCPYMTGELNRRDEVSDGDAAAATEQFLSQYYLSDNDTFMTSDVGGPIEDQNSLSAGERGPTLLEDFIFRQKIQRFDHERVPERAVHARGAGAHGVFTSYGDFSNITAASFLGKEGKQTPVFVRFSTVAGSRGSSDLARDVHGFATRFYTDEGNFDIVGNNIPVFFIQDAILFPDLIHAVKPRGDNEIPQAASAHDSAWDFFSQQPSTMHTLLWAMSGHGIPRSFRHVDGFGVHTFRFVTDDGASKLVKFHWKSLQGKASMVWEEAQQTSGKNPDFMRQDLYDAIEAGRYPEWELGVQIMDEEDQLRFGFDLLDPTKIVPEEFVPITKLGKMQLNRNPRNYFAETEQVMFQPGHIVRGVDFTEDPLLQGRLFSYLDTQLNRHGGPNFEQLPINQPRVPVHNNNRDGARQMFIPLNPHAYSPKTPVNGSPKQANQTVGDGFFTAPGRTTSGKLVRAVSPSFADVWSQPRLFYNSLVPAEKQFVIDAIRFENANVKSPVVKNNVIIQLNRIDNDLARRVARAIGVAEPEPDPTFYHNNKTANVGTFGTKLKKLDGLKVGVLGSVQHPGSVEGASTLRDRLKDDGVDVVVVAERLANGVDQTYSASDAIQFDAVVVAAGAESLFTTSSFTGGSANATTGASSLYPTGRPLQILVDGFRFGKTVGALGSGAAALRNAGIATSRDGVYVAPSVTDDFANGIKEGLSTFKFLDRFPVDH

SEQ ID NO: 10 - protein, 714 aa, Talaromyces stipitatus
  mat_peptide (1)..(714)
ACPMLTGEIPAGSIANPHHLGSRADSNASDETEAFLSEFYLNDNNSFLTTDVGGPIEDQNSLKAGIRGSTLLEDFIFRQKIQRFDHERVPERAVHARGAGAHGVFTSYADWSNITAASFLGAAGKETPTFVRFSTVAGSRGSADTARDVHGFATRFYTDEGNYDIVGNNIPVFFIQDAIQFPDLIHAVKPQPASEIPQAATAHDTAYDFFGQQPSTLHTLFWAMAGHGIPRSFRHVDGFGVHAYRFVTDDGSSKLVKFHWKSLQGRASLVWEEAQATAGKNADFMRQDLFDNIAAGRYPEWELGVQLIEEPDQLSYGFDLLDPTKILPVEQVPITPLGKMQLNRNPLNYFAETEQVMFQPGHIVRGIDFTEDPLLQGRLFSYLDTQLNRNGGPNFEQIPINRPRVPIHNNNRDGFGQMFIPLNDAAYSPNTLSDGNPKQANETVGNGFFTTPGRTANGNLVRAKSPTFADVWSQPGLFYNSLTATEQQFVINALRFELANVASETVKNNFITQINRVNNTLATLVATAIGVNAPEPDPTYYHHNKTSDVGTFGTPLKKIDGLKVGVLASVNDENSISEGQSLARSLADLNVDVVIVAERLAGNVSATYSASDAINFDAVIVTSGAKGLFGPQTFTAVSNTTLYPVGRPTQILVDAFRYGKPVGAVGSASEALTVSDIDTDRSGVITGDLNDEFVKQLSEDLATFKFLDRFTVDE

SEQ ID NO: 11 - protein, 713 aa, Malbranchea cinnamomea
  mat_peptide (1)..(713)
ACPYLSGELDKRQADSSNDAAQATEEFLQQFYLNDNDTYMTTDTGTPIADQQSLSVGERGPTLLEDFIFRQKIQRFDHERVPERAVHARGAGAHGVFTSYGDFSNITAASFLSAEGKQTPVFVRFSTVAGSRGSSDMARDVHGFATRFYTDEGNFDIVGNNIPVFFIQDAIQFPDLIHAVKPKQDNEIPQAATAHDSAWDFFSQQPSTMHTLMWAMAGHGIPRSYRHMDGFGVHTFRFVTDEGQSKLVKFHFKTLQGRASMVWEEAQVISGKNTDFHRQDLFEAIESGTYPEWEFGVQIVDEEDELKFGFDLLDPTKIIPEDLVPVTPLGKLQLNRNPRNYFAETEQVMFQPGHIVRGIDFTDDPLLQGRLFSYLDTQLNRHGGPNFEQLPINQPRVPIHNNNRDGAGQMYIPLNPHAYSPNTLHASSPRQANETHGKGFFTTPGRTPSGTLQRSLSPTFADVWSQPRLFYNSLHPVERQFLVNAIRFETSNLASSVVRKNVIIQLNRISNDLARRVARFIGVEEPQPDEKFYHNNKTVPLGTFGTPLKSLAGLKIGILSSVNSYEEASRIKSALLEKDSSVKVSVVAERLVPGEEGTVAYTAADGTSFDGIIVSNGTADGFTPYASSPLFPAGRPLQILVDAYRYGKPVGAIGDAGLKALDNAGIQEAERDAEKGVFTASDADATFVEDFLDGLKVFRFLERFDIDEDAEDY

SEQ ID NO: 12 - protein, 713 aa, Crassicarpon thermophilum; identical to SEQ ID NO: 11
  mat_peptide (1)..(713)

SEQ ID NO: 13 - protein, 722 aa, Penicillium emersonii
  mat_peptide (1)..(722)
VGCPYLTGQLDARDVHNPHEFQRRQDPGDAAASTEQFLSQFYLNDSNSYMTTDVGGPISDQNSLKAGERGPTLLEDFIFRQKIQHFDHERVPERAVHARGAGAHGTFTSYGNWSNITAASFLSAEGKETPVFVRFSTVAGSRGSADTARDVHGFATRFYTDEGNFDIVGNNIPVFFIQDAILFPDLIHAVKPSPDNEIPQAATAHDTAWDFFSQQPSALHTLFWAMSGHGIPRSFRHMDGFGVHTFRFVTDDGASKLVKFHWTSLQGRASLVWEEAQAAAGKNLDYMRQDLYDNIEAGRYPEWELGIQIVDEEDQLKFGFDLLDPTKIIPVEYVPITPLGKLQLNRNPLNYFAETEQIMFQPGHIVRGIDFTEDPLLQGRLFSYLDTQLNRNGGPNFEQLPINRPRVPWHNNNRDGFSQAFIPLNKAAYSPNTLNNGNPKQANQTVGDGFFTTPGRTTSGRLMRTVSSTFSDVWSQPRLFYNSLVPAEQQFLVNAIRFENSNVKSEVVRNNVIIQLNRVDNDLARRVARVIGVAEPEPDPTYYHNNKTANVGTFGTPLKRIDGLKVGVLATVGDPDSISQGQSLSDALSDSKVDVTVVAESFTDGVDALYTNSDATGFDAVIVADGAEGLFTPSSFTAKPTNSFSTTTLYPAGRPLQILVDAFRFGKPVGALGSGAKALDAAGISTSRPGVYVANSTSEAFTDDIEDGLRTFKFLDRFALDE

SEQ ID NO: 14 - protein, 706 aa, Aspergillus versicolor
  mat_peptide (1)..(706)
ACPFIGGGGGLERRDTNPDATEATEEFLSEYYFDDNDVYLTSDVGGPIEDQQSLKAGERGSTLLEDFIFRQKIQRFDHERVPERAVHARGTGAHGVFTSYGDYSNITAASFLSSKGKETPVFVRFSTVAGSRGSSDLARDVHGFATRFYTDEGNFDLVGNNIPIFFIQDAIQFPDLIHSVKPSGNNEIPQAATAHDAAWDFFSQQPSTMHTLLWAMSGNGIPRSFRHVDGFGVHTFRFVTDHGSTKFVKFHWKTLQGKAGLVWEEAQQISGKNPDYMRQDLYEAIDAGRFPEWELAVQIMDEEDQLRFGFDLLDPTKIVPEEYVPLTKIGKMTLNRNPRNYFAETEQVMFQPGHIVRGVDFSEDPLLQGRLFSYLDTQLNRNGGPNFEQLPINQPRVPVHNNNRDGAGQMFIPLNPNAYSPNTLNKASPKQANQTVGRGFFTAPDRKANGNLVRVKSSTFEDVWSQPRLFYNSLVPAEKQFVVNAIRFENANVKSEVVKKNVIIQLNRISNDLATRVASAIGVDAPEPDQKYYHDNTTVGVGAFGHKLQKLAGLKVAVLASVDADQSFSAATALSAELSDNGVDVVVVAERLAEGVNQTYSASDAIQFDAVVLAPGTEKLFNSTTTASSTLYPAGRPLQILTDAFRWGKPVAALGSSSGALKSASIGQKDDGVYVAKSVNSDFASQLEQGLTVFRFLDRFALDSDK

SEQ ID NO: 15 - protein, 699 aa, Thermomucor indicae-seudaticae
  mat_peptide (1)..(699)
EENMNHECAFQYGLPGSDAKDLQLERFTIIDAGTQETTNYGVRINNSESLKAGLRGPTLMEDFMMREKIMHFVHARGVGAHGYFESYADWSNITAAKFLSAPGKKTPVFVRFSTVLGFKGSPDTVRDDRGFATRFYTEDGNFDLVGNVIPPFFVQDAIKFPDLIHAAKPEPDTQVPQAGTAHDTAYDFFSSFPETLHTVLWVLSGRGIPRSFRQVEGFGIHTFRLINEEGKAVFVKFIWKPKQGLSNLIWDEAQKIAGKDIDFHRNDLYNAINRGDYPEYELCVQIVPEQDEFKFDFDLLDPTKLIPESIVPVTKLGKLVLNRNVENFFSETEQITLHPGHLVRGIGFTNDPLLQGRLFSYFDTQINRMNSVNFLQIPINRPIVPVHNNQRDGYMQQNIYAGKVAYYPNGLQGNTPALVDPDKGGYIEYPERVSGEKRRGRAPSFFDFYSQPQLFWNSLTEAEKQQLVDGARFEVGKCKSFDVRARFVDQLNHIDNGLARRVAAGVGVPLPEKMYENPGQSSVGISIEEYPKADNIRTRTVAILTAPGTNIEEARTMYGYLAQEGAYVEYIGLYLGDQDGLNITNTYLTTSSVLYDALYVPGGQEGIRKLMDKVSLFPFEEPKVFVMDAFRHGKPIAASSEGVELLMAAEVEIPNHNEDGVAYHEGVVIGNVSPPMEQKFKEALIQQRFWSRLPIDPPI

SEQ ID NO: 16 - protein, 713 aa, Aspergillus fumigatus
  mat_peptide (1)..(713)
VCPYMTGELNRRDEISDGDAAAATEEFLSQYYLNDNDAFMTSDVGGPIEDQNSLSAGERGPTLLEDFIFRQKIQRFDHERVPERAVHARGAGAHGVFTSYGDFSNITAASFLAKEGKQTPVFVRFSTVAGSRGSSDLARDVHGFATRFYTDEGNFDIVGNNIPVFFIQDAILFPDLIHAVKPRGDNEIPQAATAHDSAWDFFSQQPSTMHTLLWAMSGHGIPRSFRHVDGFGVHTFRFVTDDGASKLVKFHWKSLQGKASMVWEEAQQTSGKNPDFMRQDLHDAIEAGRYPEWELGVQIMDEEDQLRFGFDLLDPTKIVPEEFVPITKLGKMQLNRNPRNYFAETEQVMFQPGHIVRGVDFTEDPLLQGRLFSYLDTQLNRHGGPNFEQLPINQPRVPVHNNNRDGAGQMFIPLNPHAYSPKTSVNGSPKQANQTVGDGFFTAPGRTTSGKLVRAVSSSFEDVWSQPRLFYNSLVPAEKQFVIDAIRFENANVKSPVVKNNVIIQLNRIDNDLARRVARAIGVAEPEPDPTFYHNNKTADVGTFGTKLKKLDGLKVGVLGSVQHPGSVEGASTLRDRLKDDGVDVVLVAERLADGVDQTYSTSDAIQFDAVVVAAGAESLFAASSFTGGSANSASGASSLYPTGRPLQILIDGFRFGKTVGALGSGTAALRNAGIATSRDGVYVAQSVTDDFANDLKEGLRTFKFLDRFPVDH

SEQ ID NO: 17 - protein, 697 aa, Thermothelomyces thermophilus
  mat_peptide (1)..(697)
ACPFADPAALQRRDDAPPADILEKYKVDDSKGYMSSDVGGPIGDQASLRAGGRGPTLLEDFIFRQKIQHFDHERVPERAVHARGAGAHGTFTSYADWSNLTAASFLSSAGKKTPVFVRFSTVAGSRGSADTARDVHGFATRFYTDEGNFDIVGNNIPVFFIQDAIQFPDLIHSVKPRPDNEIPQAATAHDSAWDFFSSQPSTLHTLFWAMAGNGIPRSYRHMDGFGIHTFRLVKEDGSSKLVKWHWKTRQGKASLVWEEAQAVAGKNADFHRQDLWDAIESGNGPEWELGVQVVDEDKALAFGFDLLDPTKIIPEELVPITPLGVMKLDRNPTNYFAETEQIMFQPGHIVRGIDFSEDPLLQGRLFSYLDTQLNRNGGPNFEQLPINMPRAPIHNNNRDGAGQTFIHTNIYPYSPNTLNKGYPLQANQTSGRGFFTAPGRRVTGELLRELSPTFNDHWSQPRLFYNSLKPVEQQFLINAIRFETSHIRSTTVKQNVLAQLNRVSHDVAARVAAALGLEAPAPDDTYYHDNKTAGLSIFGEPLPTIKTLRVGVLASAQKDSSTLAQAGLLKAALEKDGLVVTVVGESLAEGVDQTYSAADATAFDAVIVAEGAERLFAAAGASSPLFPAGRPGQILLDAYRWGKPVGVIGKAEGAYKSAGVPVGGKGVYTAAGVDAIVKNLEEGLKTFRFTDRFPLDN

SEQ ID NO: 18 - protein, 719 aa, Curvularia verruculosa
  mat_peptide (1)..(719)
VCPYMDGNSDALPASHPVARRDGASASSTDQFMGQFEIDDSKAYLTNPVGGPIPDQESLSAGERGPTLLEDQIFRRKIMHFDHERVPERAVHARGAGAHGVFQSFGDWSNITGASFLSAPNKETPTFIRFSTVAGSRGSADTARDVHGFAVRFYTDEGNFDIVGNNVPVFFIQDAIKFPDLIHAVKPKPDREIPQAATAHDSAWDFFSQQPSTMHTLMWAMSGHGTIRSYRHTDGFGVHTFRFVRDDGKSKLVKFRFRSLQGKAALLWEEAQTTAGMNADLHRQDLFESIENGYYPEWIFEAQIMEEEDQLRFGFDLLDPTKIVPEDIVPFTPLGKLTLNRNPRNYFAETEQVMFQPGHLVRGIDITDDPLLQGRMYSYLDTQLNRNGGPNFEQIPINQPRVPIHSNERDGAGQMYIPLNTAAYSPNTLNSGFPKQANQQEGRGFFTAPSRSVSGNLVRTVSSTFADAWSQPRLFFNSLSAVEQQFVINAIRFETSQLQSEVVKNNVLIQLNRISHDIATRVAEALGMDAPAADDKFYHNNKTINVNAGGEPLLKIEGLKVGYLTSASSSGENAKALKAALKDKKVGLTVVAEHLGAGIDQTYSAASAVNFDAIIVDGSASGLFAPAGSLANSNSTASTKARSTLYPAGRPLDILQTSYKFGKPVAVLGASNNTLSTAGIEANTPGVYSLDASDMSAVVNKISEGLQTFKFLDRYPLDN

SEQ ID NO: 19 - protein, 697 aa, Mycothermus thermophilus
  mat_peptide (1)..(697)
TCPFADPAALYRRQDTTSGQSPLAAYEVDDSTGYLTSDVGGPIQDQTSLKAGIRGPTLLEDFMFRQKIQHFDHERVPERAVHARGAGAHGTFTSYADWSNITAASFLNATGKQTPVFVRFSTVAGSRGSADTARDVHGFATRFYTDEGNFDIVGNNIPVFFIQDAIQFPDLIHSVKPRPDNEIPQAATAHDSAWDFFSQQPSTMHTLFWAMSGHGIPRSYRHMDGFGVHTFRFVKDDGSSKLIKWHFKSRQGKASLVWEEAQVLSGKNADFHRQDLWDAIESGNGPEWDVCVQIVDESQAQAFGFDLLDPTKIIPEEYAPLTKLGLLKLDRNPTNYFAETEQVMFQPGHIVRGIDFTEDPLLQGRLFSYLDTQLNRNGGPNFEQLPINMPRVPIHNNNRDGAGQMFIHRNKYPYTPNTLNSGYPRQANQNAGRGFFTAPGRTVSGALVREVSPTFNDHWSQPRLFFNSLTPVEQQFLVNAMRFEISLVKSEEVRKNVLTQLNRVSHDVAGRVAAAIGLAAPDADDTYYHNNKTAGVSILGSGPLPTIKTLRVGILATTSESSALDQAAQLRTRLEKDGLVVTVVAETLREGVDQTYSTADATGFDGVVVVDGAAALFASTASSPLFPTGRPLQIFVDAYRWGKPVGVCGGKSSEVLDAADVPENGDGVYSEESVDKFVEEFEKGLATFRVSLGAFVF

SEQ ID NO: 20 - protein, 710 aa, Mycothermus thermophilus
  mat_peptide (1)..(710)
ACPYMTGELERRDTGTDDATAATEEFLSQYYMADNDTFLTSDVGGPIEDQNSLQVGDRGPTLLEDFIFRQKIQRFDHERVPERAVHARGVGAHGVFTSYGDYSNITAASFLGAEGKETPVFVRFSTVAGSRGSSDLARDVHGFATRFYTDEGNFDIVGNNIPVFFIQDAILFPDLIHAVKPRGDNEIPQAATAHDSAWDFFSQQPSSLHTLLWAMSGHGIPRSLRHVDGFGIHTFRFVTDNGDSKLVKFHWKSLQGKASMVWEEAQQVSGKNPDFMRQDLFEAIEAGRYPEWELGVQIMDEEDQLKFGFDLFDPTKIVPEEYVPITKLGKMTLNRNPRNYFAETEQVMFQPGHIVRGVDFTEDPLLQGRLFSYLDTQLNRHGGPNFEQLPINQPRVPVHNNNRDGAGQMFIPLNPNAYSPNTLNKGSPKQANQTVGKGFFTAPGRESTGRFTRAVSPSFEDVWSQPRLFYNSLTPAEQQFVVDAIRFENSNVKSSVVRNNVIIQLNRVSNDLARRVARAIGVEEPEADPTYYHNNKTTDVGTFGQKLKKLDGLKVGFLASVETPASIEAASELSKQLSEDGVDVVVVAERLSDGVDQTYSGSDAIQFDAVIVAPGAEGLFSTFSFTAPSNATSSSTLFPAGRPLQIVIDGFRFGKPVGAVGSAATALKNAGIQTSRDGVYVDKSVTSGFVDGIKDGLRTFKFLDRFKLDH

SEQ ID NO: 21 - protein, 714 aa, Penicillium oxalicum
  mat_peptide (1)..(714)
ACPYMTGETAGLDRRGEKDAASGTEEFLSEFYLKDDENVFLTSDVGGPIEDQNSLKAGERGPTLLEDFIFRQKIQRFDHERVPERAVHARGAGAHGVFTSYGDWSNITAASFLSAEGKETPMFVRFSTVAGSRGSADTARDVHGFATRFYTDEGNFDIVGNNIPVFFIQDAIKFPDLIHAVKPRGDNEIPQAATAHDSAWDFFSQQPSSLHTLLWAMAGHGIPRSFRHVDGFGVHTYRLVTDKGDTKLVKFHWKGLQGKASLVWEEAQQVAGKNGDFMRQDLFDAIEAGRYPEWELGVQIMEEDDQLRFGFDLLDPTKIVPEELVPVVKLGKMTLNRNPMNYFAETEQVMFQPGHIVRGVDFTDDPLLQGRIYSYLDTQLNRHGGPNFEQIPINRPRVPIHNNNRDGAGQMYIPLNPNAYSPNTLNKGSPKQANETVGKGFFTAPGRTSSGKLLRAVSSTFEDVWSQPRLFWNSLVPAEQQFVVDAMRFENANVMSQVVRNNVVIQLNRISNDLAKRVAEAIGVDAPQPDPTYYHDNTTANIGAFGQKLKKLEGLKVGVLASVANASSISQGAALQSQLKDVGVDLVVVGERMAHGVNQTYSASDAINFDAVIVADGAEGLFSTSSSTVSPKAKSSGATSLYPAGRPMDILLDAFRFGKPVGSLGQGSVALENAQISSDRDGVYAAKSVDEDFGDKVKEGLRTFKFLDRFALDE

SEQ ID NO: 22 - protein, 697 aa, Humicola hyalothermophila
  mat_peptide (1)..(697)
ACPFADAAAFAKRDDSQSSDFFGRYKIDDSDGYMTSDVGGPIEEQFSLKAGIRGSTLLEDFIFRQKIQHFDHERVPERAVHARGAGAHGTFTSYADWSNLTAASFLNAAGKETPVFVRFSTVAGSRGSADTARDVHGFAVRFYTDEGNFDIVGNNIPVFFIQDAIRFPDLIHSVKPSPDSEIPQGATAHDSAWDFFSSQPSTMHTLFWAMAGYGIPRSYRHMDGFGVHTFRFVKDDGSSKLVKFHFKTLQGRASLVWEEAQVLAGKNADFHRQDLWDAIESGNGPEWEFAVQVVDEDKALAFGFDVLDPTKIIPEEFAPLTKLGKLKLNRNPTNYFAETEQVMFQPGHIVRGVDFSEDPLLQGRLFSYLDTQLNRHGGPNFEQIPINMPRVPIHNNNRDGAGQGFIHTNIYPYTPNTLNKGFPKQATREEGRGFFTAPGRTASGQLVRALSPTFDDHWSQPRLFYNSLTPVEQQFVINAMRFETSNVKSVEVRKNVIAQLNRVSHDVASRVAAALGLEAPAPEDQFYHNNVTAGISIFNGTLPTIRTLRVGVLASAGNRAVLGQAAELKERFAADGLVVTVVGEYLADGVDQTYSGADATGFDGVVVVDGAESLFDDKGSKSPLFPVGRPGQILLDAYRWGKPVAGLGKANQALRSVGVPTNNAPGVFVESGVEELVKAFEGGLQTFRFTDRFALDE

SEQ ID NO: 23 - protein, 723 aa, Thermoascus crustaceus
  mat_peptide (1)..(723)
ACPYMTGELPRSFAENPHDIHRRAEGGGAADETEKFLSRFYLNDNDTFMTSDVGGPIAEQNSLSAGERGPTLLEDFIFRQKIQHFDHERVPERAVHARGVGAHGVFTSYGNWSNITAASFLAAEGKETPVFVRFSTVAGSRGSADTARDVHGFATRFYTDEGNFDIVGNNIPVFFIQDAILFPDLIHAVKPSPENEIPQAATAHDSAWDFFSQQPSSLHTLFWAMAGHGIPRSFRTVDGFGIHTFRFVTDDGASKLVKFHWKSLQGKASLVWEEAQAVAGKNADYHRQDLYNAIEAGRYPEWELGVQIMDEEDQLRFGFDVMDPTKIVPEEYVPITKLGKMQLNRNPLNYFSETEQIMFQPGHIVRGIDFSEDPLLQGRLFSYLDTQLNRHGGPNFEQIPINRPRIPIHNNNRDGAAQMYIPLNKAAYSPNTLNNGSPKQANQTVGKGFFTTPGRTANGKLVRSVSSTFADVWTQPRLFYNSLVPAEQQFLINAIRFETAHLKSSVVKNNVIIQLNRVSNNLAKRVARAIGVEEPEPDPTFYHNNKTANVAVFGQPLARLDGLQVGVLASVDKADSIKQAASLKDSFAKDNVDVMVVAERLADGVDLTYSAADAVNFDAILVANGADDLFTRDSFTAKPSNSSSATLYPAGRPLQILVDGFRFGKPVGAFGSGAKALDAAEISTKRAGVYVADSTSDDFVKGVKDGLRTFKFLDRFAIDEDAE

SEQ ID NO: 24 - protein, 702 aa, Thielavia australiensis
  mat_peptide (1)..(702)
ACPFANTGALNEKRDDSQSPDFLDKYKVDDSEGFMTSDVGGPIGDQFSLKAGIRGSTLLEDFIFRQKIQHFDHERVPERAVHARGAGAHGTFTSYADWSNLTAASFLNAAGKKTPVFVRFSTVAGSRGSADTVRDVHGFATRFYTDEGNFDIVGNNIPIFFIQDAIHFPDLIHAVKPRPDNEIPQAATAHDSAWDYFSSQPSTMHTLFWAMAGYGIPRSFRHMDGFGVNTYRFVKEDGSSTLIKWHLKTLQGKASLVWEEAQAVAGKNPDFHRQDLWDAIESGNHPSWELAVQVADEDKALAFGFDLLDPTKFIPEELAPLTRLGVMTLDRNPTNYFAETEQVMFQPGHVVRGVDFSEDPLLQGRLFSYLDTQLNRHRGPNFEQLPINMPRIPIHNNNRDGAGQGFIHKNVYHYSPNTLNNGFPLQANQTAGRGFFTAPGRVANGNLVRARSPTFDDHWSQPRLFYNSLTPVEQQLLINAIRFETSHLTSTTVKQNVLAQLNRVSNDVAARVAAALGLEAPAPDPTFYHDNVTAGLSIVNATLPTIKTLRVGVLASTASAGSLAQAAQLKERLAADGVVVSVVAETLGQGADQTYAAADATAFDGVVVADGAEGLFGDAAGPAAASSSLFPAGRPGQILVDAYRWGKPVGALGGAEKALESVGALSGSQPGVLTQSEVEEFVKGFEEGLAKFRFTDRFPLDS

SEQ ID NO: 25 - protein, 766 aa, Thielavia hyrcaniae
  mat_peptide (1)..(766)
GCPYADVHKRDGLSERADGFSIDTLSTSFGKCPSISDAAGGGTRSHDWWPCQLRLDVLRQFSPQQDPFGGNFDYAAAFATLDYKALKADLKALLTQSQPWWPADFGHYGGLFIRLAWHSAGTYRAIDGRGGGGMGQIRFAPLNSWPDNGNLDKARRLLWPIKQKYGKAISWADLFILAGNVALEEMGFPVLGFGAGRLDTWQSDESVYWGSETTWVPKGNDVRYNGSTDYAGRSSQLEKPLAAAHMGLIYVNPQGPDGNPDPKLSALDIRTTFGRMGMNDSETVALIAGGHAFGKAHGASNAAVGPAPEGAALEAQGFGWANPFGSGNAANTITSGLEVIWSKTPTKWSNNFLTSLFKNEWTLTKSPAGAHQFIALQGSQDYPEPFDNKTFRRPTMLVSDLALREDPTYGAIARAWVDDFPAFTRAFAAAWFKLTHRDMGPVARYLGPEVPKERFIWQDPLPAATSQPISDGEQEKLKADIFALPGITISSLVSVAWASASTFRGGDKRGGANGARIALQPQVSWEVNNPKQLQTVLGALNTLKETFNKSPGGKKQVSLADLIVLAGNAAIEHAAAAAGYKNTRVPFTPGRVDATQSDTDVASFEYLNPQADGFRNFRNFSGWARARTEELLVDKAQQLTLTPPEMTVLVGGMRALGANYDGSSTGVLTSRPGTLSNDFFANLLDVGTVWTAEAASGGEVFTGKDRATGQKKWTASRADLVFGSHAELRAIAEVYAEAGGQDKMVADFVAAWAKVMDLDRFDVKKK

SEQ ID NO: 26 - protein, 701 aa, Neurospora crassa
  mat_peptide (1)..(701)
ACPFADPSALGRRAEGGEVDARQRLKEVEVDDNGQFMTTDFGGNIEEQFSLKAGGRGSTLLEDFIFRQKLQHFDHERIPERVVHARGAGAHGIFTSYGDWSNITAASFLGAKDKQTPVFVRFSTVAGSRGSADTARDVHGFATRFYTDEGNFDIVGNNIPVFFIQDAIRFPDLIHSVKPSPDNEVPQAATAHDSAWDFFSSQPSALHTLFWAMSGNGIPRSYRHMDGFGIHTFRLVTEDGKSKLVKWHWKTKQGKAALVWEEAQVLAGKNADFHRQDLWDAIESGNAPSWELAVQLIDEDKAQAYGFDLLDPTKFLPEEFAPLQVLGEMTLNRNPMNYFAETEQISFQPGHIVRGVDFTEDPLLQGRLYSYLDTQLNRHRGPNFEQLPINRPVSGVHNNHRDGQGQAWIHKNIHHYSPSYLNKGYPAQANQTVGRGFFTTPGRTASGVLNRELSATFDDHYTQPRLFFNSLTPVEQQFVINAIRFEASHVTNEQVKKNVLEQLNKISNDVAKRVAVALGLEAPQPDPTYYHNNVTRGVSIFNESLPTIATLRVGVLSTTKGGSLDKAKALKEQLEKDGLKVTVIAEYLASGVDQTYSAADATAFDAVVVAEGAERVFSGKGAMSPLFPAGRPSQILTDGYRWGKPVAAVGSAKKALQSIGVEEKEAGVYAGAQDEVIKGVEEGLKVFKFLERFAVDGDDEE

SEQ ID NO: 27 - protein, 739 aa, Neurospora crassa
  mat_peptide (1)..(739)
NHTPAAPELVARQKAKEALTSAPSSKKVDDLKNEFKETDKSARLTTDYGVKQTTADDWLRIVSDDKIGPSLLEDPFARERIMRFDHERIPERVVHARGSGAFGKFKVYESASDLTMAPVLTDTSRETPVFVRFSTVLGSRGSADTVRDVRGFAVKFYTEEGNWDLVGNNIPVFFIQDAIKFPDVIHAGKPEPHNEVPQAQSAHNNFWDFQFNHTEATHMFTWAMSDRAIPRSLRMMQGFGVNTYTLINAQGKRHFVKFHWTPELGVHSLVWDEALKLAGQDPDFHRKDLWEAIENGAYPKWKFGIQAIAEEDEHKFDFDILDATKIWPEDLVPVRYIGEMELNRNPDEFFPQTEQIAFCTSHVVNGIGFSDDPLLQGRNFSYFDTQISRLGVNFQELPINRPVCPVMNFNRDGAMRHTISRGTVNYYPNRFDACPPASLKEGGYLEYAQKVAGIKARARSAKFKEHFSQAQLFYNSMSPIEKQHMINAFGFELDHCEDPVVYGRMVQRLADIDLGLAQTIAEMVGGEAPTTTNHPNHGRKTINLSQTEFPPATPTIKSRRVAIIIADGYDNVAYDAAYAAISANQAIPLVIGPRRSKVTAANGSTVQPHHHLEGFRSTMVDAIFIPGGAKAAETLSKNGRALHWIREAFGHLKAIGATGEAVDLVAKAIALPQVTVSSEAEVHESYGVVTLKKVKPESFTDAVKIAKGAAGFLGEFFYAIAQHRNWDRELDGLHSMIAY

SEQ ID NO: 28 - protein, 159 aa, Armillaria ostoyae
  mat_peptide (1)..(159)
DSLVSQAVSVMTGPGQVKGTVIFQQSSVDGPVHITGRIEGLDPSALRGFHVHTSGNLTGGCDSTGEHWNPFNTNHGGLQDPKDQRHVGDLGNVKTDANGVATLDITDDIMSLNGPLSIVGRAIVVHAGTDDLGKGGTPLSLVNGNSGARVSCGVIVSTF

SEQ ID NO: 29 - protein, 307 aa, Trichoderma reesei
  mat_peptide (1)..(307)
MRPSGFLAVLSTALVGYAAAKDAPVVIDNPQGVEFKASLPKKPFFAGAALVGNVKGSVSATAGPAGKGVRFRVQFENLPKTGGPFLYHIHEEPAVNGNCTSTLAHLDPYHRGETPACNASEPQTCQVGDLSGKYGKITSDPFVAEYFDLYTSLQPGSPAFFGNRSIVIHYANKTRLTCANFAKLPVPAATTVPSTTGAHHTAIHGPLATGGAQHNLTGSHNTTGHHNFTSPHRTTGAASPSDVYTLTSVVTVPGSPTTSSSLTTTDDAGSGGASATSSVVPFPGAASGNRVSLSLLSGVVAAIFFSL

SEQ ID NO: 30 - protein, 166 aa, Aspergillus templicola
  mat_peptide (1)..(166)
QDKTAPVVTDNKPWRTYTAELQDKDNTTLRGQVTTYGPTDGVGIRLKVSFWGIPEGETLQYHIHAKPVPEDGNCYATAKHLDPYGRTDTPPCDIKNPASCEVGDLSGKHGPVWVPSGHSFNAEYTDYFLSNVEGEEAFFGDLSVVVHASDTSRLNCGNFKGFFESD

SEQ ID NO: 31 - protein, 162 aa, Aspergillus japonicus
  mat_peptide (1)..(162)
DTSAPIVWDNNDSVWQVQLLHKDNTTVQGHLKASPGPDNVGITIHAKFWGIPTDQQPLLYHIHKKRVPEDGNCYSTSSHLDPYGRTDTPPCDIKAPQTCEVGDLSGKHGPIWAAPGEPVAVSYTDWFLSNVEDTPGFIGNLSVVVHAADNTRLTCGNFEEAD

(19) United States
(12) Patent Application Publication
(10) Pub. No.: US 2023/0363419 A1
(43) Pub. Date: Nov. 16, 2023

(54) Enzymatic Feed Preservation

(71) Applicant: Novozymes A/S, Bagsvaerd (DK)

(72) Inventors: Steffen Kayser, Humelbaek (DK); Christian Nyffenegger, Hvidovre (DK); Marianne Thorup Cohn, Nordhavn (DK); Flemming Borup, Tygelsjoe (SE)

(73) Assignee: Novozymes A/S, Bagsvaerd (DK)

(21) Appl. No.: 18/029,586

(22) PCT Filed: Oct. 7, 2021
(86) PCT No.: PCT/EP2021/077789

§ 371 Date: Mar. 30, 2023

(30) Foreign Application Priority Data
Oct. 7, 2020 (EP) 20200651.6

(51) Int. Cl. A23K 20/189; A23K 30/00

(52) U.S. Cl. CPC A23K 20/189; A23K 30/00; C12Y 111/01016; C12Y 111/01021; C12Y 115/01001

(57) ABSTRACT

Animal feeds are preserved using an enzymatic antioxidant. Polypeptides having catalase activity and/or superoxide dismutase activity preserve animal feed or animal feed additives or prevent the degradation of the proteins, vitamins fats and lipids contained in animal feed components.

This application contains a Sequence Listing in computer readable form, which is incorporated herein by reference.

### FIELD OF THE INVENTION

Anti-oxidative enzymes for preserving animal feed or an animal feed additive or for preventing the oxidative degradation of the fats, lipids, proteins and vitamins contained in animal feed components.

### BACKGROUND OF THE INVENTION

Antioxidants prevent rancidity caused by oxidation of lipids. Commonly used antioxidants are synthetic chemicals, leading to concerns among regulatory bodies and customers regarding the safety of these compounds.

Typical animal feeds include feed grains such as corn to provide carbohydrates and fiber, protein sources such as soybean meal, and other ingredients. The feed grains are harvested and processed into animal feed, and the animal feed is transported and stored prior to feeding the animals. Unfortunately, the feed grains and other ingredients of the animal feed may grow mold and/or fungus after a period of storage when their moisture content is sufficiently high. The presence of mold or fungus can destroy the usefulness of the animal feed. Unless preserving additives are utilized, mold growth can occur resulting in production of enzymes which reduce complex carbohydrates to simple sugars and bacteria thriving on the sugars attack protein turning it into indigestible material, resulting in a loss of 25-35% of the dry matter, and a bad odor is produced.

While antioxidants have been added as feed preservatives to prevent degradation of the fats and lipids contained in animal feed components, many of these antioxidants, such as ethoxyquin, mixed tocopherols (vitamin E), vitamin C, and butylated hydroxyanisole/butylated hydroxytoluene, are expensive and must be obtained from a source outside the rendering industry. In addition, the FDA and other regulatory agencies, as well as consumers, have expressed concern about the safety of synthetic antioxidants such as ethoxyquin, BHT and BHA. As such, the industry seeks natural solutions to extend the shelf life of its products in an affordable manner while maintaining product freshness and quality.

WO 2104/014860 discloses an antioxidant for preserving food products wherein the antioxidant is extracted from animal tissues.

There is the need in the art is a biological alternative preservative antioxidant that can be used as a feed preservative in a cost-effective manner and that can be easily and efficiently obtained, and can meet the regulatory and customer need and customer demand for natural antioxidant that can be used in various types of animal feeds.

### SUMMARY OF THE INVENTION

An aspect of the invention is directed to a method of preserving animal feed or an animal feed additive comprising applying to said feed or feed additive a preservative, wherein said preservative comprises a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin.

A further aspect of the invention is directed to a method for preventing the degradation of the fats and lipids contained in animal feed components comprising applying a preservative to said animal feed or to an animal feed additive or feed ingredient in said animal feed, wherein said preservative comprises a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin.

The invention is further directed to a preserved animal feed composition comprising a feed grain stored under aerobic conditions said composition comprising a polypeptide selected from the group consisting of a polypeptide having catalase activity, a polypeptide having superoxide dismutase activity, and a combination of a polypeptide having catalase activity and a polypeptide having superoxide dismutase activity, wherein the polypeptide having superoxide dismutase activity is of fungal origin.

The invention is further directed to a preserved animal feed composition comprising a feed grain stored under aerobic conditions said composition comprising a preservative, said preservative comprising a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin

A further aspect of the invention is directed to a use of a polypeptide having catalase activity, a polypeptide having superoxide dismutase activity, and a combination of a polypeptide having catalase activity and a polypeptide having superoxide dismutase activity, wherein the polypeptide having superoxide dismutase activity is of fungal origin for preserving animal feed or an animal feed additive comprising applying to said feed or feed additive a preservative.

An alternative definition of the invention is related to a use of a polypeptide having catalase activity, a polypeptide having superoxide dismutase activity, and a combination of a polypeptide having catalase activity and a polypeptide having superoxide dismutase activity, wherein the polypeptide having superoxide dismutase activity is of fungal origin for preventing the degradation of the fats and lipids contained in animal feed components comprising applying a preservative to an animal feed or to an animal feed additive or feed ingredient in said animal feed.

A further alternate aspect of the invention is directed to a use of a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin for preserving animal feed or an animal feed additive comprising applying to said feed or feed additive a preservative.

A further aspect is directed to a feed preservative composition comprising a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin, and further comprising one or more antioxidants selected from the group consisting of Vitamin A, Vitamin B6, Vitamin B12, Vitamin C, Vitamin D, Vitamin E, Vitamin K, Carotenoids (e.g. astaxanthin, canthaxanthin, . . . ), Thiamin, Riboflavin, Niacin, Pyridoxine, Biotin, essential fatty acids, Essential oils, Methionine, Iron, Zinc, Manganese, Copper, Selenium and Iodine, wherein said feed preservative composition is substantially free of Butylated hydroxytoluene (BHT), Butylated hydroxyanisole (BHA) and Ethoxyquin.

An aspect of the invention is directed to use of a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin for preserving animal feed or an animal feed additive comprising applying to said feed or feed additive a preservative.

The invention is furthermore directed to use of a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin, for preventing the degradation of the fats and lipids contained in animal feed components comprising applying a preservative to said animal feed or to an animal feed additive or feed ingredient in said animal feed.

A further aspect of the invention is directed to a feed preservative composition comprising a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin; and further comprising one or more antioxidants selected from the group consisting of Vitamin A, Vitamin B6, Vitamin B12, Vitamin C, Vitamin D, Vitamin E, Vitamin K, Carotenoids (e.g. astaxanthin, canthaxanthin, . . . ), Thiamin, Riboflavin, Niacin, Pyridoxine, Biotin, essential fatty acids, Essential oils, Methionine, Iron, Zinc, Manganese, Copper, Selenium and Iodine, wherein said feed preservative composition is substantially free of Butylated hydroxytoluene (BHT), Butylated hydroxyanisole (BHA) and Ethoxyquin.

A further aspect of the invention is directed to a method of preserving a component in a feed or feed additive comprising applying a preservative to said feed or feed additive, wherein said preservative comprises a polypeptide selected from the group consisting of a polypeptide having catalase activity, a polypeptide having superoxide dismutase activity, and a combination of a polypeptide having catalase activity and a polypeptide having superoxide dismutase activity, wherein the polypeptide having superoxide dismutase activity is of fungal origin, wherein the component of the feed or feed additive is selected from the group consisting of a vitamin, a protein and a lipid.

The invention is furthermore directed to use of an enzyme selected from the group consisting of a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin, for reducing or preventing necrosis or apoptosis of intestinal cells in an animal.

The invention is furthermore directed to a method of preventing the oxidative degradation of a composition or components of said composition comprising the use of preservative, wherein said preservative comprises a polypeptide selected from the group consisting of a polypeptide having catalase activity; a polypeptide having superoxide dismutase activity; and a combination of a polypeptide having catalase activity and a polypeptide having superoxide dismutase activity, wherein the polypeptide having superoxide dismutase activity is of fungal origin.

### OVERVIEW OF SEQUENCE LISTING

SEQ ID NO 1 is the amino acid sequence of a mature polypeptide having catalase activity available from Thermoascus aurantiacus.

SEQ ID NO 2 is the amino acid sequence of a mature polypeptide having catalase activity available from Thermoascus aurantiacus.

SEQ ID NO 3 is the amino acid sequence of a mature polypeptide having catalase activity available from Thermoascus aurantiacus.

SEQ ID NO 4 is the amino acid sequence of a mature polypeptide having catalase activity available from Thermoascus aurantiacus.

SEQ ID NO 5 is the amino acid sequence of a mature polypeptide having catalase activity available from Thermoascus aurantiacus.

SEQ ID NO 6 is the amino acid sequence of a mature polypeptide having catalase activity available from Thermoascus aurantiacus.

SEQ ID NO 7 is the amino acid sequence of a mature polypeptide having catalase activity from Aspergillus niger comprising 714 amino acid residues.

SEQ ID NO 8 is the amino acid sequence of a mature polypeptide having catalase activity from Aspergillus niger comprising 730 amino acid residues. SEQ ID NO 7 is sold under the tradename Catazyme™.

SEQ ID NO 9 is the amino acid sequence of a mature polypeptide having catalase activity available from Aspergillus lentulus.

SEQ ID NO 10 is the amino acid sequence of a mature polypeptide having catalase activity available from Talaromyces stipitatus.

SEQ ID NO 11 is the amino acid sequence of a mature polypeptide having catalase activity available from Malbranchea cinnamomea.

SEQ ID NO 12 is the amino acid sequence of a mature polypeptide having catalase activity available from Crassicarpon thermophilum.

SEQ ID NO 13 is the amino acid sequence of a mature polypeptide having catalase activity available from Penicillium emersonii.

SEQ ID NO 14 is the amino acid sequence of a mature polypeptide having catalase activity available from Aspergillus versicolor.

SEQ ID NO 15 is the amino acid sequence of a mature polypeptide having catalase activity available from Thermomucor indicae-seudaticae.

SEQ ID NO 16 is the amino acid sequence of a mature polypeptide having activity available from Aspergillus fumigatus.

SEQ ID NO 17 is the amino acid sequence of a mature polypeptide having catalase activity available from Thermothelomyces thermophilus.

SEQ ID NO 18 is the amino acid sequence of a mature polypeptide having catalase activity available from Curvularia verruculosa.

SEQ ID NO 19 is the amino acid sequence of a mature polypeptide having catalase activity available from Mycothermus thermophilus

SEQ ID NO 20 is the amino acid sequence of a mature polypeptide having catalase activity available from Mycothermus thermophilus.

SEQ ID NO 21 is the amino acid sequence of a mature polypeptide having catalase activity available from Penicillium oxalicum.

SEQ ID NO 22 is the amino acid sequence of a mature polypeptide having catalase activity available from Humicola hyalothermophila.

SEQ ID NO 23 is the amino acid sequence of a mature polypeptide having catalase activity available from Thermoascus crustaceus.

SEQ ID NO 24 is the amino acid sequence of a mature polypeptide having catalase activity available from Thielavia australiensis.

SEQ ID NO 25 is the amino acid sequence of a mature polypeptide having catalase activity available from Thielavia hyrcaniae.

SEQ ID NO 26 is the amino acid sequence of a mature polypeptide having catalase activity available from Neurospora crassa.

SEQ ID NO 27 is the amino acid sequence of a mature polypeptide having catalase activity available from Neurospora crassa.

SEQ ID NO 28 is the amino acid sequence of a mature polypeptide having superoxide dismutase activity available from Armillaria ostoyae.

SEQ ID NO 29 is the amino acid sequence of a mature polypeptide having superoxide dismutase activity available from Trichoderma reesei.

SEQ ID NO 30 is the amino acid sequence of a mature polypeptide having superoxide dismutase activity available from Aspergillus templicola.

SEQ ID NO 31 is the amino acid sequence of a mature polypeptide having superoxide dismutase activity available from Aspergillus japonicus.

### BRIEF DESCRIPTION OF FIGURES

FIG. 1 is a comparison between Vitamin E and the vitamin e analogue Trolox. The ROS reactive hydroxyl group is highlighted in both molecules.

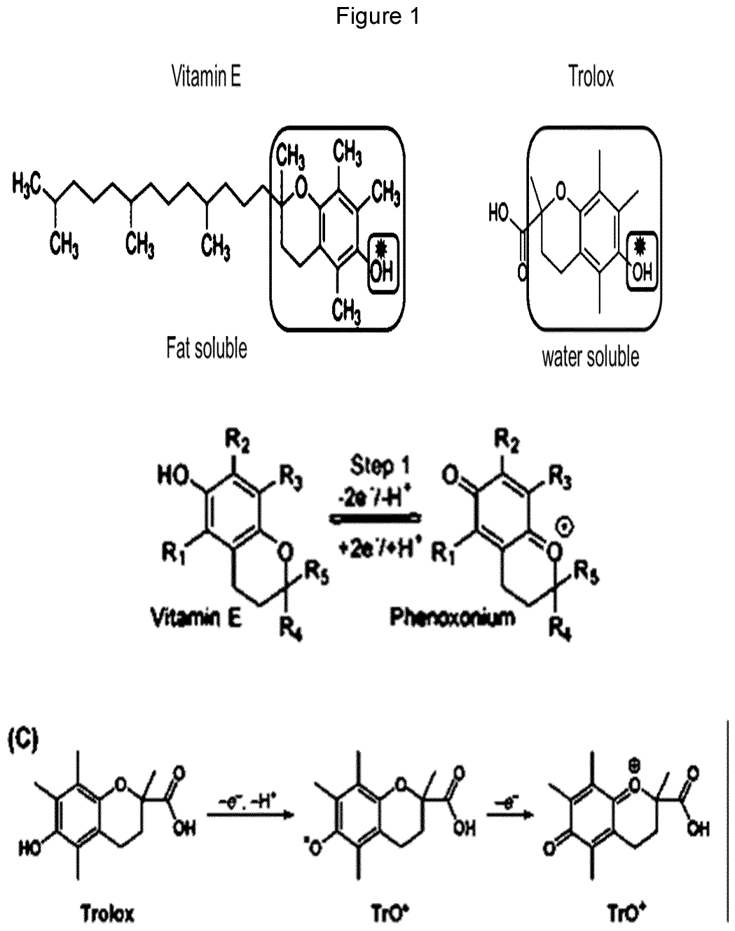

FIG. 2 is a competition assay for superoxide. Superoxide is formed in situ by hypoxanthine and xanthine oxidase. Superoxide is quantified by the radical indicator WST-1. The more superoxide present, the more (faster) formazan is formed, which absorbs at 450 nm. This leads to a steep increase in Abs450 over time. If an SOD or some other superoxide consuming compound like Trolox is added, less superoxide is left for the coloring reaction leading to a less steep increase in Abs450.

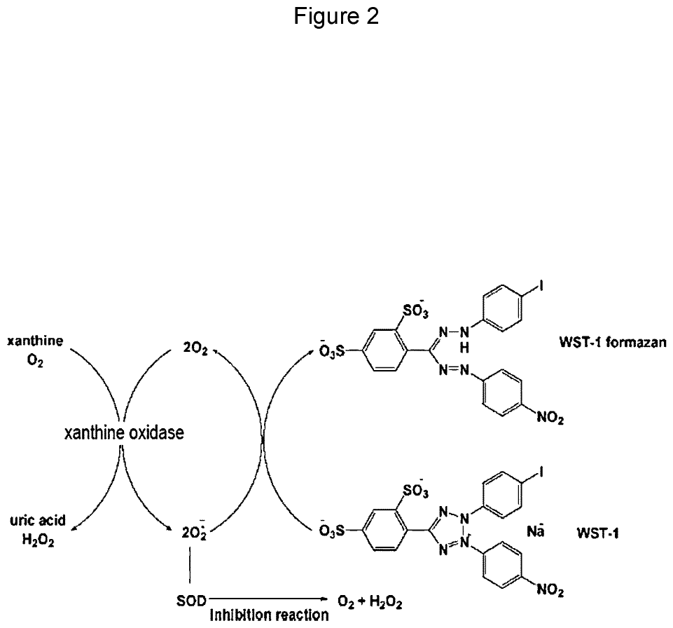

FIG. 3 illustrates how hydrogen peroxide or Trolox is quantified through the formation of ABTSox in a coupled reaction with peroxidases (POD) and ABTSred.

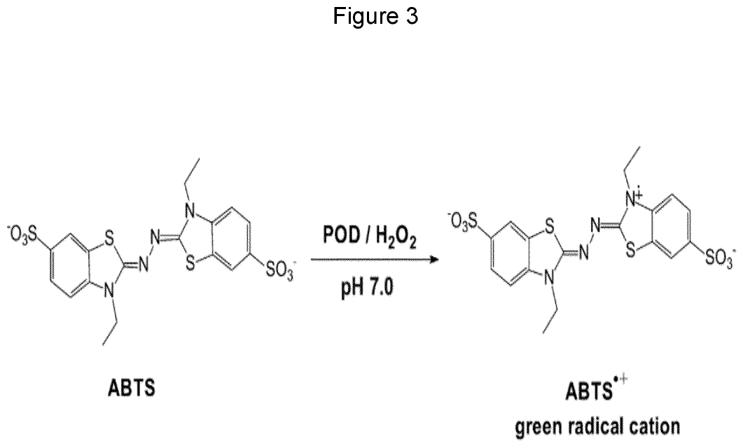

FIG. 4 illustrates how a polyunsaturated fatty acid reacts with ROS and forms a lipid radical. This lipid radical reacts further to form a peroxyl radical, which in turn ends up as malondialdehyde (MDA), a fingerprint for lipid oxidation.

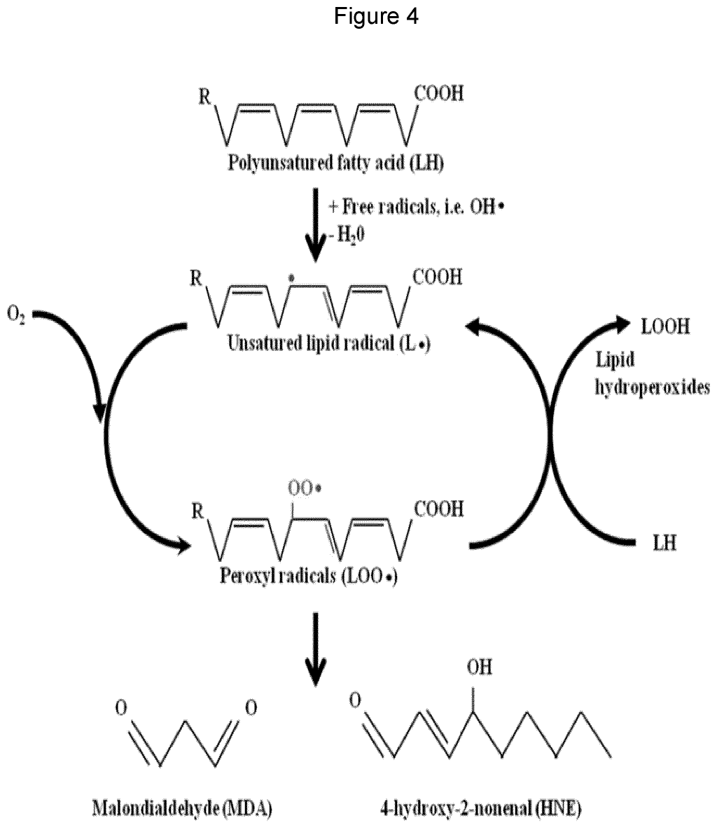

FIG. 5 illustrates the effect of ROS on 0.5 μg/μL α-linolenic acid. MDA serves as a fingerprint for lipid oxidation and is quantified via TBARS fluorescence.

FIG. 6 illustrates the effect of ROS on 5 μg/μL α-linolenic acid. MDA serves as a fingerprint for lipid oxidation and is quantified via TBARS fluorescence.

### DETAILED DESCRIPTION OF THE INVENTION

The invention is directed to an alternative biological solution to chemicals, including vitamins, to preserve animal feed components. The enzyme biological solutions of the invention can be used independent of or in combination with the chemical solutions presently on the market.

### Definitions

Animal: The term “animal” refers to any animal except humans. Examples of animals are monogastric animals, including but not limited to pigs or swine (including, but not limited to, piglets, growing pigs, and sows); poultry such as turkeys, ducks, quail, guinea fowl, geese, pigeons (including squabs) and chicken (including but not limited to broiler chickens (referred to herein as broiles), chicks, layer hens (referred to herein as layers)); pets such as cats and dogs; horses (including but not limited to hotbloods, coldbloods and warm bloods) crustaceans (including but not limited to shrimps and prawns) and fish (including but not limited to amberjack, arapaima, barb, bass, bluefish, bocachico, bream, bullhead, cachama, carp, catfish, catla, chanos, char, cichlid, cobia, cod, crappie, dorada, drum, eel, goby, goldfish, gourami, grouper, guapote, halibut, java, labeo, lai, loach, mackerel, milkfish, mojarra, mudfish, mullet, paco, pearlspot, pejerrey, perch, pike, pompano, roach, salmon, sampa, sauger, sea bass, seabream, shiner, sleeper, snakehead, snapper, snook, sole, spinefoot, sturgeon, sunfish, sweetfish, tench, terror, tilapia, trout, tuna, turbot, vendace, walleye and whitefish).

Animal feed: The term “animal feed” refers to any compound, preparation, or mixture suitable for, or intended for intake by an animal. Animal feed for a monogastric animal typically comprises concentrates as well as vitamins, minerals, enzymes, direct fed microbial, amino acids and/or other feed ingredients (such as in a premix) whereas animal feed for ruminants generally comprises forage (including roughage and silage) and may further comprise concentrates as well as vitamins, minerals, enzymes direct fed microbial, amino acid and/or other feed ingredients (such as in a premix).

Concentrates: The term “concentrates” means feed with high protein and energy concentrations, such as fish meal, molasses, oligosaccharides, sorghum, seeds and grains (either whole or prepared by crushing, milling, etc. from e.g. corn, oats, rye, barley, wheat), oilseed press cake (e.g. from cottonseed, safflower, sunflower, soybean (such as soybean meal), rapeseed/canola, peanut or groundnut), palm kernel cake, yeast derived material and distillers grains (such as wet distillers grains (WDS) and dried distillers grains with solubles (DDGS)).

Feed Premix: The incorporation of the composition of feed additives as exemplified herein above to animal feeds, for example poultry feeds, is in practice carried out using a concentrate or a premix. A premix designates a preferably uniform mixture of one or more microingredients with diluent and/or carrier. Premixes are used to facilitate uniform dispersion of micro-ingredients in a larger mix. A premix according to the invention can be added to feed ingredients or to the drinking water as solids (for example as water soluble powder) or liquids.

Forage: The term “forage” as defined herein also includes roughage. Forage is fresh plant material such as hay and silage from forage plants, grass and other forage plants, seaweed, sprouted grains and legumes, or any combination thereof. Examples of forage plants are Alfalfa (lucerne), birdsfoot trefoil, brassica (e.g. kale, rapeseed (canola), rutabaga (swede), turnip), clover (e.g. alsike clover, red clover, subterranean clover, white clover), grass (e.g. Bermuda grass, brome, false oat grass, fescue, heath grass, meadow grasses, orchard grass, ryegrass, Timothy-grass), corn (maize), millet, barley, oats, rye, sorghum, soybeans and wheat and vegetables such as beets. Forage further includes crop residues from grain production (such as corn stover; straw from wheat, barley, oat, rye and other grains); residues from vegetables like beet tops; residues from oilseed production like stems and leaves form soy beans, rapeseed and other legumes; and fractions from the refining of grains for animal or human consumption or from fuel production or other industries.

Fragment: The term “fragment” means a polypeptide or a catalytic domain having one or more (e.g., several) amino acids absent from the amino and/or carboxyl terminus of a mature polypeptide or domain; wherein the fragment has SOD activity.several) amino acids absent from the amino and/or carboxyl terminus of a mature polypeptide or domain; wherein the fragment has SOD activity.

Fungal origin: The term “fungal origin is intended to mean, in reference to a superoxide dismutase, that the source of the enzyme in a fungus. A fungus is any member of the group of eukaryotic organisms that includes microorganisms such as yeasts and molds, as well as the more familiar mushrooms. These organisms are classified as a kingdom, fungi. Currently, seven phyla are proposed: Microsporidia, Chytridiomycota, Blastocladiomycota, Neocallimastigomycota, Glomeromycota, Ascomycota, and Basidiomycota. Suitable examples include, without limitation, Trichoderma reesei, Aspergillus versicolor, Aspergillus deflectus, Aspergillus egyptiacus, Westerdykella sp. AS85-2, Aspergillus sp. XZ2669, Preussia terricola, Kionochaeta sp., Metapochonia bulbillosa, Xylomelasma sp. XZ0718, Preussia flanaganii, Cladobotryum sp., Westerdykella sp-46156, Trichoderma hamatum, Mycothermus thermophilus, Cephalotrichiella penicillate, Chaetomium megalocarpum, Chaetomium thermophilum var. thermophilum, Humicola hyalothermophila, Subramaniula anamorphosa, Sphingobacterium sp. T2,

Trichoderma rossicum, Trichoderma lixii, Trichoderma sp-54723, Aspergillus niveus, Aspergillus templicola, Pochonia chlamydosporia var. spinulospora, Trichoderma sp-44174, Trichoderma rossicum, Trichoderma sp-54723, Trichoderma sp-44174, Metapochonia suchlasporia, Metarhizium marquandii, Diaporthe nobilis, Tolypocladium sp. XZ2627, Aspergillus japonicus, Metarhizium sp. XZ2431, Armillaria ostoyae, Trichoderma spirale, Aspergillus elegans, Trichoderma sinuosum, Trichoderma virens, Trichoderma harzianum, Fusicolla acetilerea, Plectosphaerella sp. 1-29, Mariannaea punicea, Penicillium oxalicum, Colletotrichum sp-71086, Aspergillus sp. nov. XZ3202, Trichoderma parapiluliferum, Aspergillus sp. nov. XZ3202, Mucor sp. XZ2651, Rhizomucor miehei, Mucor sp. XZ2651, Amphisphaeriaceae-sp 43674, Humicola fuscoatra and Valsaria rubricosa.

Isolated: The term “isolated” means a substance in a form or environment that does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., multiple copies of a gene encoding the substance; use of a stronger promoter than the promoter naturally associated with the gene encoding the substance). An isolated substance may be present in a fermentation broth sample.

Mature polypeptide: The term “mature polypeptide” means a polypeptide in its final form following translation and any post-translational modifications, such as N-terminal processing, C-terminal truncation, glycosylation, phosphorylation, etc.

Physical determination of the mature N terminus of SODs was done with Mass Spectrometry. Samples were diluted to 0.1 mg/ml in water. If they were to be deglycosylated before analysis, the samples were suspended in 50 mM Ammonium acetate buffer pH 5.5. The samples are then placed in an Ultimate 3000 UHPLC system (Thermo Scientific) at 8 degrees C. and run over an Advance Bio-RP desalting column (Agilent) The solvents used were A: LC/MS grade water with 0.1% formic acid, solvent: B 95% acetonitrile with 0.1% formic acid. The gradient was 5-80% B over 5 minutes. Post column the protein eluent was analyzed in a Bruker Maxis II mass spectrometer (Bremen Germany) and the resulting trace was analyzed by the supplied Bruker data analysis software. The deconvoluted spectrum was then compared to the calculated molecular weight with the expected N and C terminals using GPMAW (General Protein/Mass Analysis for Windows) software version 12.20. If the values match within 1 Dalton, a match was concluded.

Obtained or obtainable from: The term “obtained or obtainable from” means that the polypeptide may be found in an organism from a specific taxonomic rank. In one embodiment, the polypeptide is obtained or obtainable from the kingdom Fungi, wherein the term kingdom is the taxonomic rank. In a preferred embodiment, the polypeptide is obtained or obtainable from the phylum Ascomycota, wherein the term phylum is the taxonomic rank. In another preferred embodiment, the polypeptide is obtained or obtainable from the subphylum Pezizomycotina, wherein the term subphylum is the taxonomic rank. In another preferred embodiment, the polypeptide is obtained or obtainable from the class Eurotiomycetes, wherein the term class is the taxonomic rank.

If the taxonomic rank of a polypeptide is not known, it can easily be determined by a person skilled in the art by performing a BLASTP search of the polypeptide (using e.g. the National Center for Biotechnology Information (NCIB) website http://www.ncbi.nlm.nih.gov/) and comparing it to the closest homologues. The skilled person can also compare the sequence to those of the application as filed. An unknown polypeptide which is a fragment of a known polypeptide is considered to be of the same taxonomic species. An unknown natural polypeptide or artificial variant which comprises a substitution, deletion and/or insertion in up to 10 positions is considered to be from the same taxonomic species as the known polypeptide.

Roughage: The term “roughage” means dry plant material with high levels of fiber, such as fiber, bran, husks from seeds and grains and crop residues (such as stover, copra, straw, chaff, sugar beet waste).

Sequence identity: The relatedness between two amino acid sequences or between two nucleotide sequences is described by the parameter “sequence identity”.

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

Substantially pure polypeptide: The term “substantially pure polypeptide” means a preparation that contains at most 10%, at most 8%, at most 6%, at most 5%, at most 4%, at most 3%, at most 2%, at most 1%, and at most 0.5% by weight of other polypeptide material with which it is natively or recombinantly associated. Preferably, the polypeptide is at least 92% pure, e.g., at least 94% pure, at least 95% pure, at least 96% pure, at least 97% pure, at least 98% pure, at least 99%, at least 99.5% pure, and 100% pure by weight of the total polypeptide material present in the preparation. The polypeptides of the present invention are preferably in a substantially pure form. This can be accomplished, for example, by preparing the polypeptide by well known recombinant methods or by classical purification methods.

Tm: The term Tm, as used in the Examples refers to the temperature at which 50% of the protein molecules are unfolded and 50% of the protein molecules are folded.

Variant: The term “variant” means a polypeptide having SOD activity comprising an alteration, i.e., a substitution, insertion, and/or deletion, of one or more (several) amino acid residues at one or more (e.g., several) positions. A substitution means replacement of the amino acid occupying a position with a different amino acid; a deletion means removal of the amino acid occupying a position; and an insertion means adding 1, 2, or 3 amino acids adjacent to and immediately following the amino acid occupying the position.

Nutrient: The term “nutrient” in the present invention means components or elements contained in dietary feed for an animal, including water-soluble ingredients, fat-soluble ingredients and others. The example of water-soluble ingredients includes but is not limited to carbohydrates such as saccharides including glucose, fructose, galactose and starch; minerals such as calcium, magnesium, zinc, phosphorus, potassium, sodium and sulfur; nitrogen source such as amino acids and proteins, vitamins such as vitamin B1, vitamin B2, vitamin B3, vitamin B6, folic acid, vitamin B12, biotin and phatothenic acid. The example of the fat-soluble ingredients includes but is not limited to fats such as fat acids including saturated fatty acids (SFA); mono-unsaturated fatty acids (MUFA) and poly-unsaturated fatty acids (PUFA), fibre, vitamins such as vitamin A, vitamin E and vitamin K.

Superoxide: Superoxide is the name of the short-lived, membrane impermeable superoxide radical anion, which is created when molecular oxygen captures a single electron.

The superoxide radical ion can acts as a one-electron reducing agent, if it donates electrons to a molecule (=acceptor) other than itself. In this process, the superoxide radical is oxidised (=looses the electron) and the acceptor “accepts” the electron and thereby gets reduced.

O₂·⁻+acceptor→O₂+acceptor·⁻

The reduced acceptor could get even further reduced by accepting another electron from a second superoxide radical molecule.

O₂·⁻+acceptor·⁻−→O₂+acceptor·⁻

If no acceptor accepts the electron from superoxide, two superoxide molecules will react with each other, forming hydrogen peroxide.

O₂·⁻+O₂·⁻+2H⁺→O₂+H₂O₂

However this second reduction of superoxide requires the compression of two full negative charges on the diatomic oxygen molecule, which is an energetically disfavourable process. As a result, superoxide is generally a better reducing agent than oxidizing agent.

This can also be seen from the superoxide radical anion's negative redox potential. A negative redox potential means, that the superoxide radical anion wants to get rid of the electron, rather than oxygen wants to accept an electron. (Hydrogen peroxide in contrast has a positive redox potential, it wants to accept electrons, thereby oxidising the molecule it accepts the electrons from.)

Superoxide dismutase: Superoxide dismutases (SOD) catalize this energetically unfavourable reaction of two superoxide molecules (=dismutation of superoxide) into hydrogen peroxide and water.

$${O}_{2}^{\cdot –} + {O}_{2}^{\cdot –} + 2 {H}^{+} {\to }^{Superoxide dismutase} {O}_{2} + {H}_{2} {O}_{2}$$

SOD's thus remove a reducing agent. In other words, SODs are pro-oxidants, not antioxidants. The beneficial effect os SODs arises from their capability to remove the reactive and damaging superoxide radical ion rather than being an antioxidant.

Reactive oxygen species: Both hydrogen peroxide and superoxide are reactive oxygen species.

Due to their reactive nature they react with biomolecules and damage/deactivate those. CAT and SOD “disarm” these reactive oxygen species so they cannot damage/deactivate biomolecules.

### ROS Include

H₂O₂
KO₂
HX/XO

Table of reactive oxygen species and enzymes acting on the various ROS types:

| ROS | Representation | Half-life (s) |
|---|---|---|
| Superoxide | O2^{•-} | 10⁻⁶ |
| anion | | |
| Hydrogen | H2O2 | Stable |
| peroxide | | |
| Hydroxyl | OH^{•} | 10⁻⁹ |
| radical | | |
| Nitric oxide | NO | |
| Peroxinitrite | ONOO⁻ | |
| anion | | |
| Peroxyl | RCOO^{•} | Seconds |
| radical | | |
| Organic | RCOOH | Stable |
| hydroperoxide | | |
| Singlet | ¹O₂ | 10⁻⁶ |
| oxygen | | |
| Ozone | O₃ | seconds |

### Methods of the Invention

A first aspect of the invention is directed to a method of preserving animal feed or an animal feed additive comprising applying to said feed or feed additive a preservative, wherein said preservative comprises a polypeptide having superoxide dismutase activity, or a combination of a polypeptide having catalase activity and a polypeptide having superoxide dismutase activity, wherein the polypeptide having superoxide dismutase activity is of fungal origin. Typically, in the method of preserving animal feed or an animal feed additive, said animal feed or an animal feed additive is under aerobic conditions.

A further aspect is directed to a method for preventing the oxidative degradation of vitamins, proteins, fats and lipids contained in animal feed components comprising applying a preservative to said animal feed or to an animal feed additive or feed ingredient in said animal feed, wherein said preservative comprises a polypeptide having superoxide dismutase activity, or a combination of a polypeptide having catalase activity and a polypeptide having superoxide dismutase activity, wherein the polypeptide having superoxide dismutase activity is of fungal origin. Typically, in the method for preventing the degradation of vitamins, proteins, fats and lipids contained in animal feed components, said animal feed or an animal feed additive or feed ingredient is under aerobic conditions.

In the methods of the invention, the level of chemical preservative applied to said animal feed or an animal feed additive is typically reduced compared to an animal feed or an animal feed additive absent of a polypeptide having catalase activity or absent of a polypeptide having superoxide dismutase activity.

The polypeptide having catalase activity is preferably dosed at a level of 50 to 1000 U enzyme protein per kg animal feed, such as 100 to 1000 U enzyme protein per kg animal feed, such as 200 to 900 U, 300 to 800, 400 to 700, 500 to 600 enzyme protein per kg animal feed, or any combination of these intervals.

In the methods of the invention, wherein the level of chemical preservative applied to said animal feed or an animal feed additive is typically reduced compared to an animal feed or an animal feed additive absent of a polypeptide having catalase activity or absent of a polypeptide having superoxide dismutase activity, the reduced chemical preservative is suitably selected from Butylated hydroxytoluene (BHT), Butylated hydroxyanisole (BHA) and Ethoxyquin.

The method may comprise adding one or more antioxidants selected from the group consisting of Vitamin A, Vitamin B6, Vitamin B12, Vitamin C, Vitamin D, Vitamin E, Vitamin K, Carotenoids (e.g. astaxanthin, canthaxanthin, . . . ), Thiamin, Riboflavin, Niacin, Pyridoxine, Biotin, essential fatty acids, Essential oils, Methionine, Iron, Zinc, Manganese, Copper, Selenium, and Iodine, preferably selected from the group consisting of Vitamin C, Vitamin E, Vitamin K and selenium.

The invention is further directed to a method for preventing the oxidative degradation of vitamins, proteins, fats and lipids contained in animal feed components comprising applying a preservative to said animal feed or to an animal feed additive or feed ingredient in said animal feed, wherein said preservative comprises a vitamin selected from the group consisting of Vitamin E or derivatives thereof and Vitamin C or derivatives thereof; and a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin.

The invention is further directed to a method for preventing the oxidative degradation of vitamins, proteins, fats and lipids contained in animal feed components comprising applying a preservative to said animal feed or to an animal feed additive or feed ingredient in said animal feed, wherein said preservative comprises selenium, and a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin.

A further aspect is directed to a method of preserving a component in a feed or feed additive comprising applying a preservative to said feed or feed additive, wherein said preservative comprises a polypeptide selected from the group consisting of a polypeptide having catalase activity, a polypeptide having superoxide dismutase activity, and a combination of a polypeptide having catalase activity and a polypeptide having superoxide dismutase activity, wherein the polypeptide having superoxide dismutase activity is of fungal origin, wherein the component of the feed or feed additive is selected from the group consisting of a vitamin, a protein and a lipid.

A further aspect is directed to a method of preventing the oxidative degradation of a composition or components of said composition comprising the use of preservative; wherein said preservative comprises a polypeptide selected from the group consisting of a polypeptide having catalase activity; a polypeptide having superoxide dismutase activity; and a combination of a polypeptide having catalase activity and a polypeptide having superoxide dismutase activity, wherein the polypeptide having superoxide dismutase activity is of fungal origin.

The methods of invention relate to the administration of animal feed to an animal. The animal is typically a mono-gastric animal, e.g. pigs or swine (including, but not limited to, piglets, growing pigs, and sows); poultry (including but not limited to poultry, turkey, duck, quail, guinea fowl, goose, pigeon, squab, chicken, broiler, layer, pullet and chick); pets (including but not limited to cats and dogs); fish (including but not limited to amberjack, arapaima, barb, bass, bluefish, bocachico, bream, bullhead, cachama, carp, catfish, catla, chanos, char, cichlid, cobia, cod, crappie, dorada, drum, eel, goby, goldfish, gourami, grouper, guapote, halibut, java, labeo, lai, loach, mackerel, milkfish, mojarra, mudfish, mullet, paco, pearlspot, pejerrey, perch, pike, pompano, roach, salmon, sampa, sauger, sea bass, seabream, shiner, sleeper, snakehead, snapper, snook, sole, spinefoot, sturgeon, sunfish, sweetfish, tench, terror, tilapia, trout, tuna, turbot, vendace, walleye and whitefish); and crustaceans (including but not limited to shrimps and prawns). In a more preferred embodiment, the animal is selected from the group consisting of swine, poultry, crustaceans and fish. In an even more preferred embodiment, the animal is selected from the group consisting of swine, piglet, growing pig, sow, chicken, broiler, layer, pullet and chick. In a further preferred embodiment, the animal is selected from the group consisting of swine, piglet, growing pig and sow.

A further aspect of the invention is directed to a method of feeding an animal, such as poultry or pigs, comprising adding a preservative to a raw feed material, wherein said preservative comprises a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin.

A further aspect of the invention is directed to a method of feeding an animal, wherein the animal feed or animal feed additive comprises a preservative, wherein said preservative comprises a polypeptide having catalase activity and a polypeptide having superoxide dismutase activity, or a combination of a polypeptide having catalase activity and a polypeptide having superoxide dismutase activity, wherein the polypeptide having superoxide dismutase activity is of fungal origin and further comprises one or more components selected from the list consisting of:
i. one or more carriers;
ii. one or more microbes;
iii. one or more vitamins;
iv. one or more minerals;
v. one or more amino acids;
vi. one of more organic acids;
vii. and one or more other feed ingredients.

One may furthermore administer additional enzymes but enzymes other than a catalase and a superoxide dismustase are not essential for the beneficial effects of the invention. The polypeptide having superoxide dismutase activity is suitably obtained, obtainable from or originating from Armillaria ostoyae, Aspergillus japonicus, Trichoderma reesei, and Aspergillus templicola. The polypeptide having superoxide dismutase activity is suitably selected from the group consisting of a polypeptide having:
i) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:28;
ii) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:29;
iii) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:30; and
iv) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:31.

A further aspect of the invention is directed to a use of an enzyme selected from polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin for preserving animal feed or an animal feed additive comprising applying to said feed or feed additive a preservative.

An alternative definition of the invention is related to a use of an enzyme selected from polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin for preventing the degradation of the vitamins, proteins, fats and lipids contained in animal feed components comprising applying said enzyme to an animal feed or to an animal feed additive or feed ingredient in said animal feed.

### Feed Preservative Compositions, Animal Feed Additive and Animal Feed

A biological solution which is superior to chemical solutions has been found. It has been found that either or both of catalases of the invention and superoxide dismutases of the invention are superior in their anti-oxidant effect in feed compared to vitamin E. A calculation using SEQ ID NO 31, based on validated data, finds the latter to have a 2700-fold higher anti-oxidant effect compared to vitamin E.

An aspect of the invention is directed to a preserved animal feed composition comprising a feed grain stored under aerobic conditions said composition comprising a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin. Typically, the preserved animal feed composition comprises a reduced level of chemical preservative compared to an animal feed or an animal feed additive absent of a polypeptide having catalase activity. The animal feed composition may comprise one or more antioxidants selected from the group consisting of Vitamin A, Vitamin B6, Vitamin B12, Vitamin C, Vitamin D, Vitamin E, Vitamin K, Carotenoids (e.g. astaxanthin, canthaxanthin, . . . ), Thiamin, Riboflavin, Niacin, Pyridoxine, Biotin, essential fatty acids, Essential oils, Methionine, Iron, Zinc, Manganese, Copper, Selenium and Iodine. The preserved animal feed composition typically comprises a reduced level of chemical preservative selected from Butylated hydroxytoluene (BHT), Butylated hydroxyanisole (BHA) and Ethoxyquin. The preserved animal feed composition may be substantially absent or absent a content of Butylated hydroxytoluene (BHT), Butylated hydroxyanisole (BHA) and Ethoxyquin.

In a typical embodiment, the animal feed composition comprises a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin and further comprises a vitamin selected from the group consisting of Vitamin E or a derivative thereof and Vitamin C or a derivative thereof.

In a typical embodiment, the animal feed composition comprises a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin and further comprises selenium.

The preserved animal feed composition may comprise one or more components selected from the list consisting of:
i. one or more carriers;
ii. one or more microbes;
iii. one or more amino acids;
iv. one of more organic acids;
v. and one or more other feed ingredients.

The preserved animal feed composition may comprise the polypeptide having catalase activity at a dose of 50 to 1000 U enzyme protein per kg animal feed, such as 100 to 1000 U enzyme protein per kg animal feed, such as 200 to 900 U, 300 to 800, 400 to 700, 500 to 600 enzyme protein per kg animal feed, or any combination of these intervals.

The protein source of preserved animal feed composition may be selected from the group consisting of soybean, wild soybean, beans, lupin, tepary bean, scarlet runner bean, slimjim bean, lima bean, French bean, Broad bean (fava bean), chickpea, lentil, peanut, Spanish peanut, canola, sunflower seed, cotton seed, rapeseed (oilseed rape) or pea or in a processed form such as soybean meal, full fat soy bean meal, soy protein concentrate (SPC), fermented soybean meal (FSBM), sunflower meal, cotton seed meal, rapeseed meal, fish meal, bone meal, feather meal, whey or any combination thereof.

The energy source of preserved animal feed composition may be selected from the group consisting of maize, corn, sorghum, barley, wheat, oats, rice, triticale, rye, beet, sugar beet, spinach, potato, cassava, quinoa, cabbage, switchgrass, millet, pearl millet, foxtail millet or in a processed form such as milled corn, milled maize, potato starch, cassava starch, milled sorghum, milled switchgrass, milled millet, milled foxtail millet, milled pearl millet, or any combination thereof.

The preserved animal feed composition is typically such that the polypeptide having catalase activity is obtained or obtainable from or originating from a fungus selected from the group consisting of Thermoascus aurantiacus and Aspergillus niger, preferably Thermoascus aurantiacus. The polypeptide having catalase activity may be selected from the group consisting of
a. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 1;
b. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 2;
c. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:3;
d. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:4;
e. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:5;
f. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:6;
g. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:7;
h. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:8;
i. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 9;
j. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 10;
k. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 11;
l. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 12;
m. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 13;
n. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 14:
o. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 15;
p. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 16;
q. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 17;
r. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 18;
s. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 19;
t. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 20;
u. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 21;
v. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 22;
w. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 23;
x. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 24;
y. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 25;
z. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 26; and
aa. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 27.

The polypeptide having catalase activity is more typically selected from the group consisting of
a. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 1;
b. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 2;
c. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:3;
d. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:4;
e. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:5; and
f. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:6.

The polypeptide having superoxide dismutase activity is obtained, obtainable from or originating from Armillaria ostoyae, Aspergillus japonicus, Trichoderma reesei, and Aspergillus templicola. Typically, the polypeptide having superoxide dismutase activity is selected from the group consisting of a polypeptide having:
i) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:28;
ii) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:29;
iii) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:30; and
iv) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:31.

In a preferred example, the animal feed may further comprise one or more components selected from the list consisting of one or more additional enzymes; one or more microbes; one or more vitamins; one or more minerals; one or more amino acids; and one or more other feed ingredients, as described herein.

The invention, in a further aspect, is directed to an animal feed additive and to an animal feed comprising the feed preservative composition as defined herein.

The feed preservative composition comprises a polypeptide having catalase activity, and further comprising one or more antioxidants selected from the group consisting of Vitamin A, Vitamin B6, Vitamin B12, Vitamin C, Vitamin D, Vitamin E, Vitamin K, Carotenoids (e.g. astaxanthin, canthaxanthin, . . . ), Thiamin, Riboflavin, Niacin, Pyridoxine, Biotin, essential fatty acids, Essential oils, Methionine, Iron, Zinc, Manganese, Copper, Selenium and Iodine, wherein said feed preservative composition is typically substantially free of Butylated hydroxytoluene (BHT), Butylated hydroxyanisole (BHA) and Ethoxyquin

The feed preservative composition may comprise
a. one or more polypeptides having catalase activity, wherein the feed preservative composition further comprises
b. one or more polypeptides having superoxide dismutase activity and
c. one or more vitamins, wherein the one or more vitamins is preferably a fat-soluble vitamin, for example vitamin E.

In a further embodiment, the feed preservative composition may further comprise one or more components selected from the list consisting of:
i. one or more carriers;
ii. one or more microbes;
iii. one or more amino acids; and
iv. one of more organic acids.

The polypeptide having catalase activity is preferably dosed at a level of 50 to 1000 U enzyme protein per kg animal feed, such as 100 to 1000 U enzyme protein per kg animal feed, such as 200 to 900 U, 300 to 800, 400 to 700, 500 to 600 enzyme protein per kg animal feed, or any combination of these intervals.

### Preventing Oxidation of Vitamins

Reactive oxygen species (ROS) are reactive chemicals formed from O2 and include hydrogen peroxide and superoxide. ROS can be formed from oxygen as a metabolic/respiratory byproduct or by other factors such as heat, radiation (UV, ionizing), drought, salinity, chilling, defense of pathogens, nutrient deficiency, metal toxicity, toxins, xenobiotics, and pollutants. ROS can lead to cellular and systemic redox imbalance. To re-establish the redox balance, antioxidants such as vitamin E (vitamin C, . . . ) are added to food and feed. After systemic uptake, vitamin E inserts itself into the plasma membrane of cells and scavenges reactive oxygen species, thereby protecting the cell from ROS damage in a rather inefficient way, where one molecule of vitamin E can scavenge one molecule of ROS.

Vitamin E is easily oxidized and thus is added as a vitamin-ester, i.e. a protected form, to food and feed. When consumed, esterases in the intestinal lumen cleave the ester bond and release the free (now unprotected) vitamin E. Until taken up, the free vitamin E is subject to ROS in the gut lumen. We therefore assessed whether catalases and/or superoxide dismutases can protect Vitamin E from ROS mediated degradation along the gastrointestinal tract. This would allow intact Vitamin E being taken up systemically and thus would result in unlocking the full potential of vitamin E.

It has been found herein that SOD has much higher efficiency in disarming superoxide compared to Trolox. It has been found herein that catalase has much higher efficiency in disarming hydrogen peroxide than Trolox. In the lumen, SOD and CAT disarm superoxide and hydrogen peroxide and thus protect Trolox and vitamin E. The vitamin can thus be taken up intact systemically and can exert its antioxidant effect when entering into the cell membrane. Accordingly, each of superoxide dismutase and catalase play a protective role with vitamin E.

An aspect of the invention is directed a method of preventing the oxidation of a vitamin component in a feed or feed additive comprising applying a preservative to said feed or feed additive, wherein said preservative comprises a polypeptide selected from the group consisting of a polypeptide having catalase activity, a polypeptide having superoxide dismutase activity, and a combination of a polypeptide having catalase activity, a polypeptide having superoxide dismutase activity, wherein the polypeptide having superoxide dismutase activity is of fungal origin.

### Preventing Oxidation of Lipids

The importance of the effect of reactive oxygen species in association with lipids and fatty acids Reactive oxygen species (ROS) are reactive chemicals formed from 02 and include hydrogen peroxide and superoxide and play an important role in the oxidation of lipids and fatty acids. ROS can be formed from oxygen as a metabolic/respiratory byproduct or by other factors such as heat, radiation (UV, ionizing), drought, salinity, chilling, defense of pathogens, nutrient deficiency, metal toxicity, toxins, xenobiotics, and pollutants. Fatty acids and lipids like e.g. polyunsaturated fatty acids are susceptible to damage by ROS. When a polyunsaturated fatty acid reacts with an oxygen radical, it forms a lipid radical. This lipid radical can react further to form a peroxyl radical. In a well-defined chain reaction, the peroxyl radical ends up as malondialdehyde (MDA), a fingerprint for lipid oxidation.

An aspect of the invention is directed a method of preventing the oxidation of a lipid or fatty acid component in a feed or feed additive comprising applying a preservative to said feed or feed additive, wherein said preservative comprises a polypeptide selected from the group consisting of a polypeptide having catalase activity, a polypeptide having superoxide dismutase activity, and a combination of a polypeptide having catalase activity, a polypeptide having superoxide dismutase activity, wherein the polypeptide having superoxide dismutase activity is of fungal origin.

### Preventing Oxidation of Proteins

An aspect of the invention is directed a method of preventing the oxidation of a protein or polypeptide component in a feed or feed additive comprising applying a preservative to said feed or feed additive, wherein said preservative comprises a polypeptide selected from the group consisting of a polypeptide having catalase activity, a polypeptide having superoxide dismutase activity, and a combination of a polypeptide having catalase activity, a polypeptide having superoxide dismutase activity, wherein the polypeptide having superoxide dismutase activity is of fungal origin.

As shown in Example 7.1, rHSA is modified by hydrogen peroxide (+78 Da) and rHSA is further modified by superoxide (+43 Da) generated by the xanthine oxidase from hypoxanthine. Superoxide dismutase prevents this 43-dalton superoxide modification of rHSA.

It has furthermore been demonstrated that catalase exerts of protective affect on the stability of superoxide dismutase and superoxide dismutase exerts a protective affect on the stability of catalase.

### Preventing Intestinal Necrosis of Intestinal Cells

A further aspect of the invention is directed to the use of an enzyme selected from the group consisting of a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin, for reducing or preventing necrosis or apoptosis of intestinal cells in an animal.

A related aspect of the invention is directed to a method of preventing the oxidative degradation of a mammalian cells in the intestine comprising administering to a said mammal an enzyme selected from the group consisting of a polypeptide having catalase activity, a polypeptide having superoxide dismutase activity, or a combination of a polypeptide having catalase activity and a polypeptide having superoxide dismutase activity, wherein the polypeptide having superoxide dismutase activity is of fungal origin.

The animal is typically a mono-gastric animal, e.g. pigs or swine (including, but not limited to, piglets, growing pigs, and sows); poultry (including but not limited to poultry, turkey, duck, quail, guinea fowl, goose, pigeon, squab, chicken, broiler, layer, pullet and chick); pets (including but not limited to cats and dogs); fish (including but not limited to amberjack, arapaima, barb, bass, bluefish, bocachico, bream, bullhead, cachama, carp, catfish, catla, chanos, char, cichlid, cobia, cod, crappie, dorada, drum, eel, goby, goldfish, gourami, grouper, guapote, halibut, java, labeo, lai, loach, mackerel, milkfish, mojarra, mudfish, mullet, paco, pearlspot, pejerrey, perch, pike, pompano, roach, salmon, sampa, sauger, sea bass, seabream, shiner, sleeper, snakehead, snapper, snook, sole, spinefoot, sturgeon, sunfish, sweetfish, tench, terror, tilapia, trout, tuna, turbot, vendace, walleye and whitefish); and crustaceans (including but not limited to shrimps and prawns). In a more preferred embodiment, the animal is selected from the group consisting of swine, poultry, crustaceans and fish. In an even more preferred embodiment, the animal is selected from the group consisting of swine, piglet, growing pig, sow, chicken, broiler, layer, pullet and chick. In a further preferred embodiment, the animal is selected from the group consisting of swine, piglet, growing pig and sow. The mammal is typically selected from the group consisting of swine, piglet, growing pig and sow.

### Catalases

The polypeptide having catalase activity is selected from the group comprising a polypeptide classified as an EC 1.11.1.6 catalase and a polypeptide classified as an EP 1.11.1.21 catalase peroxidase.

In a preferred embodiment, the polypeptide having catalase activity is obtained or obtainable from or originating from a fungus. Typically, the polypeptide having catalase activity is obtained or obtainable from or originating from a fungus selected from the group consisting of Thermoascus aurantiacus, Aspergillus niger, Aspergillus lentulus, Aspergillus versicolor, Aspergillus fumigatus, Talaromyces stipitatus, Malbranchea cinnamomea, Crassicarpon thermophilum, Penicillium emersonii, Thermomucor indicae-seudaticae, Thermothelomyces thermophilus, Curvularia verruculosa, Mycothermus thermophilus, Penicillium oxalicum, Humicola hyalothermophila, Thermoascus crustaceus, Thielavia australiensis, Thielavia hyrcaniae and Neurospora crassa. The method according to any of claims 1 to 8, wherein the polypeptide having catalase activity is obtained or obtainable from or originating from a fungus selected from the group consisting of Thermoascus aurantiacus, Aspergillus niger, Aspergillus lentulus, Aspergillus versicolor and Aspergillus fumigatus. Preferably wherein the polypeptide having catalase activity is obtained or obtainable from or originating from a fungus selected from the group consisting of Thermoascus aurantiacus and Aspergillus niger, preferably Thermoascus aurantiacus.

The polypeptide having catalase activity is preferably selected from the group consisting of
a. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 1;
b. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 2;
c. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:3;
d. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:4;
e. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:5;
f. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:6;
g. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:7;
h. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:8;
i. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 9;
j. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 10;
k. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 11;
l. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 12;
m. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 13;
n. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 14:
o. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 15;
p. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 16;
q. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 17;
r. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 18;
s. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 19;
t. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 20;
u. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 21;
v. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 22;
w. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 23;
x. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 24;
y. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 25;
z. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 26; and
aa. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 27.

The polypeptide having catalase activity is more preferably selected from the group consisting of
a. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 1;
b. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO: 2;
c. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:3;
d. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:4;
e. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:5; and
f. a polypeptide with catalase activity having at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:6.

In a preferred embodiment, the polypeptide with catalase activity has at least 80%, at least 85%, at least 90%, at least 95%, at least 98%, at least 99%, or 100% sequence identity to any one of

SEQ ID NO:1, SEQ ID NO:2, SEQ ID NO:3, SEQ ID NO:4, SEQ ID NO:5, and SEQ ID NO:6 and is obtained, obtainable from or originating from Thermoascus aurantiacus.

### Thermal Stability of Catalases

The catalase is suitably thermal stable such that it retains at least 40% of its activity when measured at 50° C. and pH 7 such as retaining at least 50% activity, such as retaining at least 55% activity, such as retaining at least 60% activity, such as retaining at least 65% activity, such as retaining at least 70% activity, such as retaining at least 75% activity, such as retaining at least 80% activity.

### Thermal Stability at Different pHs

| | Mature | | | | | | | | |
|---|---|---|---|---|---|---|---|---|---|
| | SEQ ID | Tₘ | | | | | | | |
| Source | NO | 3 | 4 | 5 | 6 | 7 | 8 | 9 | 10 |
| Thermoascus | SEQ ID | 58.5 | 70.2 | 80.1 | 82.1 | 84.0 | 83.8 | 77.9 | 79.9 |
| aurantiacus | NO 1 | | | | | | | | |
| Aspergillus | SEQ ID | 56.0 | 68.2 | 72.2 | 72.3 | 70.2 | 67.0 | 65.7 | 66.1 |
| niger | NO 8 | | | | | | | | |
| Thermoascus | SEQ ID | 67.1 | 75.7 | 79.9 | 80.7 | 79.7 | 79.9 | 78.8 | 71.0 |
| aurantiacus | NO 2 | | | | | | | | |
| Aspergillus | SEQ ID | na | 66.5 | na | na | 85.1 | na | 72.6 | 73.4 |
| lentulus | NO 9 | | | | | | | | |
| Aspergillus | SEQ ID | na | na | na | na | 83.7 | 82.1 | 78.6 | 73.1 |
| fumigatus | NO 16 | | | | | | | | |
| Neurospora | SEQ ID | na | na | na | 9.5 | 81.8 | 81.2 | 80.5 | na |
| crassa | NO 26 | | | | | | | | |
| Malbranchea | SEQ ID | na | na | 69.7 | 77.3 | 84.2 | 85 | 85.2 | na |
| cinnamomea | NO 11 | | | | | | | | |
| Humicola | SEQ ID | na | na | 6.8 | na | na | na | 89.2 | 83.6 |
| hyalothermophila | NO 22 | | | | | | | | |
| Crassicarpon | SEQ ID | na | na | na | na | na | 85.3 | 83.3 | 73.4 |
| thermophilum | NO 12 | | | | | | | | |

In an embodiment of the invention, the catalase is thermal stable such that it retains at least 50% of its activity when measured at 50° C. and pH 5 such as retaining at least 55% activity, such as retaining at least 60% activity, such as retaining least 65% activity, such as retaining at least 70% activity, such as retaining at least 75% activity, such as retaining at least 80% activity. In an embodiment of the invention, the catalase is thermal stable such that its Tm is at least 50° C. at pH 5.

In an alternative embodiment of the invention, the catalase is thermal stable such that it retains at least 50% of its activity when measured at 50° C. and pH 4 such as retaining at least 55% activity, such as retaining at least 60% activity, such as retaining least 65% activity, such as retaining at least 70% activity, such as retaining at least 75% activity, such as retaining at least 80% activity. An aspect of the invention is directed to an animal feed additive comprising a catalase wherein the catalase is thermal stable such that its Tm is at least 50° C. at pH 4.

In an alternative embodiment of the invention, the catalase is thermal stable such that it retains at least 50% of its activity when measured at 40° C. and pH 3 such as retaining at least 55% activity, such as retaining at least 60% activity, such as retaining least 65% activity, such as retaining at least 70% activity, such as retaining at least 75% activity, such as retaining at least 80% activity. An aspect of the invention is directed to an animal feed additive comprising a catalase wherein the catalase is thermal stable such that its Tm is at least 40° C. at pH 3.

### Gastric Stability of Catalases

The catalase from Bovine Liver (Enzyme Commission (EC) Number: 1.11.1.6 CAS Number: 9001-05-2, Molecular weight: 250 kDa) has an activity of 3524 U/mg EP and a gastric stability wherein it retains only 40% of its activity under the gastric stability studies of Example 4.

In an alternative embodiment of the invention, the catalase is gastric stable such that it retains at least 40% of its activity when measured according to the test method described in Example 4, such as retaining at least 50% activity, such as retaining at least 55% activity, such as retaining at least 60% activity, such as retaining at least 65% activity, such as retaining at least 70% activity, such as retaining at least 75% activity, such as retaining at least 80% activity. As can be seen from the Table in Example 4, catalases of fungal origin retain at least 50% of their activity at pH 3 and exposure to pepsin.

### Super Oxide Dismutases

The preservative further comprises a polypeptide having superoxide dismutase activity of fungal origin. Superoxide dismutase (SOD, EC 1.15.1.1) is an enzyme that alternately catalyzes the dismutation (or partitioning) of the superoxide (O₂) radical into either ordinary molecular oxygen (O₂) or hydrogen peroxide (H₂O₂).

The superoxide dismutase of the invention may be obtainable, may be obtained, may be derived from a superoxide dismutase obtainable from a fungus selected from the group consisting of Trichoderma reesei, Aspergillus versicolor, Aspergillus deflectus, Aspergillus egyptiacus, Westerdykella sp. AS85-2, Aspergillus sp. XZ2669, Preussia terricola, Kionochaeta sp., Metapochonia bulbillosa, Xylomelasma sp. XZ0718, Preussia flanaganii, Cladobotryum sp., Westerdykella sp-46156, Trichoderma hamatum, Mycothermus thermophilus, Cephalotrichiella penicillate, Chaetomium megalocarpum, Chaetomium thermophilum var. thermophilum, Humicola hyalothermophila, Subramaniula anamorphosa, Sphingobacterium sp. T2, Trichoderma rossicum, Trichoderma lixii, Trichoderma sp-54723, Aspergillus niveus, Aspergillus templicola, Pochonia chlamydosporia var. spinulospora, Trichoderma sp-44174, Trichoderma rossicum, Trichoderma sp-54723, Trichoderma sp-44174, Metapochonia suchlasporia, Metarhizium marquandii, Diaporthe nobilis, Tolypocladium sp. XZ2627, Aspergillus japonicus, Metarhizium sp. XZ2431, Armillaria ostoyae, Trichoderma spirale, Aspergillus elegans, Trichoderma sinuosum, Trichoderma reesei, Trichoderma virens, Trichoderma harzianum, Fusicolla acetilerea, Plectosphaerella sp. 1-29, Mariannaea punicea, Penicillium oxalicum, Colletotrichum sp-71086, Aspergillus sp. nov. XZ3202, Trichoderma parapiluliferum, Aspergillus sp. nov. XZ3202, Mucor sp. XZ2651, Rhizomucor miehei, Mucor sp. XZ2651, Amphisphaeriaceae-sp 43674, Humicola fuscoatra and Valsaria rubricosa.

The superoxide dismutase is typically selected from those disclosed in WO 2020/200321. In suitable embodiment, the superoxide dismustase is obtained or obtainable from Armillaria ostoyae, Aspergillus japonicus, Trichoderma reesei, and Aspergillus templicola. In a suitable embodiment, the superoxide dismutase is selected from a polypeptide having:
i) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:28;
ii) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:29;
iii) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:30; and
iv) at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to SEQ ID NO:31.

### Enzyme Compositions and Formulations

The polypeptide having catalase activity of the invention may be formulated as a liquid or a solid. For a liquid formulation, the formulating agent may comprise a polyol (such as e.g. glycerol, ethylene glycol or propylene glycol), a salt (such as e.g. sodium chloride, sodium benzoate, potassium sorbate) or a sugar or sugar derivative (such as e.g. dextrin, glucose, sucrose, and sorbitol). Thus, in one embodiment, the composition is a liquid composition comprising the polypeptide of the invention and one or more formulating agents selected from the list consisting of glycerol, ethylene glycol, 1,2-propylene glycol, 1,3-propylene glycol, sodium chloride, sodium benzoate, potassium sorbate, dextrin, glucose, sucrose, and sorbitol. The liquid formulation may be sprayed onto the feed after it has been pelleted or may be added to drinking water given to the animals.

In one embodiment, the liquid formulation further comprises 20%-80% polyol (i.e. total amount of polyol), preferably 25%-75% polyol, more preferably 30%-70% polyol, more preferably 35%-65% polyol or most preferably 40%-60% polyol. In one embodiment, the liquid formulation comprises 20%-80% polyol, preferably 25%-75% polyol, more preferably 30%-70% polyol, more preferably 35%-65% polyol or most preferably 40%-60% polyol wherein the polyol is selected from the group consisting of glycerol, sorbitol, propylene glycol (MPG), ethylene glycol, diethylene glycol, triethylene glycol, 1, 2-propylene glycol or 1, 3-propylene glycol, dipropylene glycol, polyethylene glycol (PEG) having an average molecular weight below about 600 and polypropylene glycol (PPG) having an average molecular weight below about 600. In one embodiment, the liquid formulation comprises 20%-80% polyol (i.e. total amount of polyol), preferably 25%-75% polyol, more preferably 30%-70% polyol, more preferably 35%-65% polyol or most preferably 40%-60% polyol wherein the polyol is selected from the group consisting of glycerol, sorbitol and propylene glycol (MPG).

In one embodiment, the liquid formulation further comprises preservative, preferably selected from the group consisting of sodium sorbate, potassium sorbate, sodium benzoate and potassion benzoate or any combination thereof. In one embodiment, the liquid formulation comprises 0.02% to 1.5% w/w preservative, more preferably 0.05% to 1.0% w/w preservative or most preferably 0.1% to 0.5% w/w preservative. In one embodiment, the liquid formulation comprises 0.001% to 2.0% w/w preservative (i.e. total amount of preservative), preferably 0.02% to 1.5% w/w preservative, more preferably 0.05% to 1.0% w/w preservative or most preferably 0.1% to 0.5% w/w preservative wherein the preservative is selected from the group consisting of sodium sorbate, potassium sorbate, sodium benzoate and potassium benzoate or any combination thereof.

For a solid formulation, the formulation may be for example as a granule, spray dried powder or agglomerate (e.g. as disclosed in WO2000/70034). The formulating agent may comprise a salt (organic or inorganic zinc, sodium, potassium or calcium salts such as e.g. such as calcium acetate, calcium benzoate, calcium carbonate, calcium chloride, calcium citrate, calcium sorbate, calcium sulfate, potassium acetate, potassium benzoate, potassium carbonate, potassium chloride, potassium citrate, potassium sorbate, potassium sulfate, sodium acetate, sodium benzoate, sodium carbonate, sodium chloride, sodium citrate, sodium sulfate, zinc acetate, zinc benzoate, zinc carbonate, zinc chloride, zinc citrate, zinc sorbate, zinc sulfate), starch or a sugar or sugar derivative (such as e.g. sucrose, dextrin, glucose, lactose, sorbitol).

In one embodiment, the composition is a solid composition, such as a spray dried composition, comprising the polypeptide having SOD activity of the invention and one or more formulating agents selected from the list consisting of sodium chloride, sodium benzoate, potassium sorbate, sodium sulfate, potassium sulfate, magnesium sulfate, sodium thiosulfate, calcium carbonate, sodium citrate, dextrin, glucose, sucrose, sorbitol, lactose, starch and cellulose. In a preferred embodiment, the formulating agent is selected from one or more of the following compounds: sodium sulfate, dextrin, cellulose, sodium thiosulfate, magnesium sulfate and calcium carbonate.

The present invention also relates to enzyme granules/particles comprising the polypeptide having catalase activity of the invention optionally combined with one or more additional enzymes. The granule is composed of a core, and optionally one or more coatings (outer layers) surrounding the core.

Typically, the granule/particle size, measured as equivalent spherical diameter (volume based average particle size), of the granule is 20-2000 μm, particularly 50-1500 μm, 100-1500 μm or 250-1200 μm.

The core can be prepared by granulating a blend of the ingredients, e.g., by a method comprising granulation techniques such as crystallization, precipitation, pan-coating, fluid bed coating, fluid bed agglomeration, rotary atomization, extrusion, prilling, spheronization, size reduction methods, drum granulation, and/or high shear granulation.

Methods for preparing the core can be found in Handbook of Powder Technology; Particle size enlargement by C. E. Capes; Volume 1; 1980; Elsevier. Preparation methods include known feed and granule formulation technologies, e.g.:
a) spray dried products, wherein a liquid enzyme-containing solution is atomized in a spray drying tower to form small droplets which during their way down the drying tower dry to form an enzyme-containing particulate material;
b) layered products, wherein the enzyme is coated as a layer around a pre-formed inert core particle, wherein an enzyme-containing solution is atomized, typically in a fluid bed apparatus wherein the pre-formed core particles are fluidized, and the enzyme-containing solution adheres to the core particles and dries up to leave a layer of dry enzyme on the surface of the core particle. Particles of a desired size can be obtained this way if a useful core particle of the desired size can be found. This type of product is described in, e.g., WO 97/23606;
c) absorbed core particles, wherein rather than coating the enzyme as a layer around the core, the enzyme is absorbed onto and/or into the surface of the core. Such a process is described in WO 97/39116.
d) extrusion or pelletized products, wherein an enzyme-containing paste is pressed to pellets or under pressure is extruded through a small opening and cut into particles which are subsequently dried. Such particles usually have a considerable size because of the material in which the extrusion opening is made (usually a plate with bore holes) sets a limit on the allowable pressure drop over the extrusion opening. Also, very high extrusion pressures when using a small opening increase heat generation in the enzyme paste, which is harmful to the enzyme;
e) prilled products, wherein an enzyme-containing powder is suspended in molten wax and the suspension is sprayed, e.g., through a rotating disk atomiser, into a cooling chamber where the droplets quickly solidify (Michael S. Showell (editor); Powdered detergents; Surfactant Science Series; 1998; vol. 71; page 140-142; Marcel Dekker). The product obtained is one wherein the enzyme is uniformly distributed throughout an inert material instead of being concentrated on its surface. Also U.S. Pat. Nos. 4,016,040 and 4,713,245 are documents relating to this technique;
f) mixer granulation products, wherein a liquid is added to a dry powder composition of, e.g., conventional granulating components, the enzyme being introduced either via the liquid or the powder or both. The liquid and the powder are mixed and as the moisture of the liquid is absorbed in the dry powder, the components of the dry powder will start to adhere and agglomerate and particles will build up, forming granulates comprising the enzyme. Such a process is described in U.S. Pat. No. 4,106,991 and related documents EP 170360, EP 304332, EP 304331, WO 90/09440 and WO 90/09428. In a particular product of this process wherein various high-shear mixers can be used as granulators, granulates consisting of enzyme as enzyme, fillers and binders etc. are mixed with cellulose fibres to reinforce the particles to give the so-called T-granulate. Reinforced particles, being more robust, release less enzymatic dust.
g) size reduction, wherein the cores are produced by milling or crushing of larger particles, pellets, tablets, briquettes etc. containing the enzyme. The wanted core particle fraction is obtained by sieving the milled or crushed product. Over and undersized particles can be recycled. Size reduction is described in (Martin Rhodes (editor); Principles of Powder Technology; 1990; Chapter 10; John Wiley & Sons);
h) fluid bed granulation, which involves suspending particulates in an air stream and spraying a liquid onto the fluidized particles via nozzles. Particles hit by spray droplets get wetted and become tacky. The tacky particles collide with other particles and adhere to them and form a granule;
i) the cores may be subjected to drying, such as in a fluid bed drier. Other known methods for drying granules in the feed or detergent industry can be used by the skilled person. The drying preferably takes place at a product temperature of from 25 to 90° C. For some enzymes it is important the cores comprising the enzyme contain a low amount of water before coating. If water sensitive enzymes are coated before excessive water is removed, it will be trapped within the core and it may affect the activity of the enzyme negatively. After drying, the cores preferably contain 0.1-10 c/o w/w water.

The core may include additional materials such as fillers, fibre materials (cellulose or synthetic fibres), stabilizing agents, solubilizing agents, suspension agents, viscosity regulating agents, light spheres, plasticizers, salts, lubricants and fragrances.

The core may include a binder, such as synthetic polymer, wax, fat, or carbohydrate.

The core may include a salt of a multivalent cation, a reducing agent, an antioxidant, a peroxide decomposing catalyst and/or an acidic buffer component, typically as a homogenous blend.

In one embodiment, the core comprises a material selected from the group consisting of salts (such as calcium acetate, calcium benzoate, calcium carbonate, calcium chloride, calcium citrate, calcium sorbate, calcium sulfate, potassium acetate, potassium benzoate, potassium carbonate, potassium chloride, potassium citrate, potassium sorbate, potassium sulfate, sodium acetate, sodium benzoate, sodium carbonate, sodium chloride, sodium citrate, sodium sulfate, zinc acetate, zinc benzoate, zinc carbonate, zinc chloride, zinc citrate, zinc sorbate, zinc sulfate), starch or a sugar or sugar derivative (such as e.g. sucrose, dextrin, glucose, lactose, sorbitol), sugar or sugar derivative (such as e.g. sucrose, dextrin, glucose, lactose, sorbitol), small organic molecules, starch, flour, cellulose and minerals and clay minerals (also known as hydrous aluminium phyllosilicates). In one embodiment, the core comprises a clay mineral such as kaolinite or kaolin.

The core may include an inert particle with the enzyme absorbed into it, or applied onto the surface, e.g., by fluid bed coating.

The core may have a diameter of 20-2000 μm, particularly 50-1500 μm, 100-1500 μm or 250-1200 μm.

The core may be surrounded by at least one coating, e.g., to improve the storage stability, to reduce dust formation during handling, or for coloring the granule. The optional coating(s) may include a salt and/or wax and/or flour coating, or other suitable coating materials.

The coating may be applied in an amount of at least 0.1% by weight of the core, e.g., at least 0.5%, 1% or 5%. The amount may be at most 100%, 70%, 50%, 40% or 30%.

The coating is preferably at least 0.1 μm thick, particularly at least 0.5 μm, at least 1 μm or at least 5 μm. In some embodiments the thickness of the coating is below 100 μm, such as below 60 μm, or below 40 μm.

The coating should encapsulate the core unit by forming a substantially continuous layer. A substantially continuous layer is to be understood as a coating having few or no holes, so that the core unit is encapsulated or enclosed with few or no uncoated areas. The layer or coating should in particular be homogeneous in thickness.

The coating can further contain other materials as known in the art, e.g., fillers, antisticking agents, pigments, dyes, plasticizers and/or binders, such as titanium dioxide, kaolin, calcium carbonate or talc.

The granule may comprise a core comprising the polypeptide having SOD activity of the invention, one or more salt coatings and one or more wax coatings. Examples of enzyme granules with multiple coatings are shown in WO1993/07263, WO1997/23606 and WO2016/149636.

A salt coating may comprise at least 60% by weight of a salt, e.g., at least 65%, at least 70%, at least 75%, at least 80%, at least 85%, at least 90%, at least 95% or at least 99% by weight.

The salt may be added from a salt solution where the salt is completely dissolved or from a salt suspension wherein the fine particles are less than 50 μm, such as less than 10 μm or less than 5 μm.

The salt coating may comprise a single salt or a mixture of two or more salts. The salt may be water soluble, in particular having a solubility at least 0.1 g in 100 g of water at 20° C., preferably at least 0.5 g per 100 g water, e.g., at least 1 g per 100 g water, e.g., at least 5 g per 100 g water.

The salt may be an inorganic salt, e.g., salts of sulfate, sulfite, phosphate, phosphonate, nitrate, chloride or carbonate or salts of simple organic acids (less than 10 carbon atoms, e.g., 6 or less carbon atoms) such as citrate, malonate or acetate. Examples of cations in these salts are alkali or earth alkali metal ions, the ammonium ion or metal ions of the first transition series, such as sodium, potassium, magnesium, calcium, zinc or aluminium. Examples of anions include chloride, bromide, iodide, sulfate, sulfite, bisulfite, thiosulfate, phosphate, monobasic phosphate, dibasic phosphate, hypophosphite, dihydrogen pyrophosphate, tetraborate, borate, carbonate, bicarbonate, metasilicate, citrate, malate, maleate, malonate, succinate, sorbate, lactate, formate, acetate, butyrate, propionate, benzoate, tartrate, ascorbate or gluconate. In particular alkali- or earth alkali metal salts of sulfate, sulfite, phosphate, phosphonate, nitrate, chloride or carbonate or salts of simple organic acids such as citrate, malonate or acetate may be used.

The salt in the coating may have a constant humidity at 20° C. above 60%, particularly above 70%, above 80% or above 85%, or it may be another hydrate form of such a salt (e.g., anhydrate). The salt coating may be as described in WO1997/05245, WO1998/54980, WO1998/55599, WO2000/70034, WO2006/034710, WO2008/017661, WO2008/017659, WO2000/020569, WO2001/004279, WO1997/05245, WO2000/01793, WO2003/059086, WO2003/059087, WO2007/031483, WO2007/031485, WO2007/044968, WO2013/192043, WO2014/014647 and WO2015/197719 or polymer coating such as described in WO 2001/00042.

Specific examples of suitable salts are NaCl (CH20° C.=76%), Na2CO3 (CH20° C.=92%), NaNO3 (CH20° C.=73%), Na2HPO4 (CH20° C.=95%), Na3PO4 (CH25° C.=92%), NH4Cl (CH20° C.=79.5%), (NH4)₂HPO4 (CH20° C.=93.0%), NH4H2PO4 (CH20° C.=93.1%), (NH4)2SO4 (CH20° C.=81.1%), KCl (CH20° C.=85%), K2HPO4 (CH20° C.=92%), KH2PO4 (CH20° C.=96.5%), KNO3 (CH20° C.=93.5%), Na2SO4 (CH20° C.=93%), K2504 (CH20° C.=98%), KHSO4 (CH20° C.=86%), MgSO4 (CH20° C.=90%), ZnSO4 (CH20° C.=90%) and sodium citrate (CH25° C.=86%). Other examples include NaH2PO4, (NH4)H2PO4, CuSO4, Mg(NO3)₂, magnesium acetate, calcium acetate, calcium benzoate, calcium carbonate, calcium chloride, calcium citrate, calcium sorbate, calcium sulfate, potassium acetate, potassium benzoate, potassium carbonate, potassium chloride, potassium citrate, potassium sorbate, sodium acetate, sodium benzoate, sodium citrate, sodium sulfate, zinc acetate, zinc benzoate, zinc carbonate, zinc chloride, zinc citrate and zinc sorbate.

The salt may be in anhydrous form, or it may be a hydrated salt, i.e. a crystalline salt hydrate with bound water(s) of crystallization, such as described in WO 99/32595. Specific examples include anhydrous sodium sulfate (Na2SO4), anhydrous magnesium sulfate (MgSO4), magnesium sulfate heptahydrate (MgSO4.7H2O), zinc sulfate heptahydrate (ZnSO4.7H2O), sodium phosphate dibasic heptahydrate (Na2HPO4.7H2O), magnesium nitrate hexahydrate (Mg(NO3)2(6H2O)), sodium citrate dihydrate and magnesium acetate tetrahydrate.

Preferably the salt is applied as a solution of the salt, e.g., using a fluid bed.

A wax coating may comprise at least 60% by weight of a wax, e.g., at least 65%, at least 70%, at least 75%, at least 80%, at least 85%, at least 90%, at least 95% or at least 99% by weight.

Specific examples of waxes are polyethylene glycols; polypropylenes; Carnauba wax; Candelilla wax; bees wax; hydrogenated plant oil or animal tallow such as polyethylene glycol (PEG), methyl hydroxy-propyl cellulose (MHPC), polyvinyl alcohol (PVA), hydrogenated ox tallow, hydrogenated palm oil, hydrogenated cotton seeds and/or hydrogenated soy bean oil; fatty acid alcohols; mono-glycerides and/or di-glycerides, such as glyceryl stearate, wherein stearate is a mixture of stearic and palmitic acid; micro-crystalline wax; paraffin's; and fatty acids, such as hydrogenated linear long chained fatty acids and derivatives thereof. A preferred wax is palm oil or hydrogenated palm oil.

Non-dusting granulates may be produced, e.g., as disclosed in U.S. Pat. Nos. 4,106,991 and 4,661,452 and may optionally be coated by methods known in the art. The coating materials can be waxy coating materials and film-forming coating materials. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591.

The granulate may further comprise one or more additional enzymes. Each enzyme will then be present in more granules securing a more uniform distribution of the enzymes, and also reduces the physical segregation of different enzymes due to different particle sizes. Methods for producing multi-enzyme co-granulates is disclosed in the ip.com disclosure IPCOM000200739D.

### Animal Feed

Animal feed compositions or diets have a relatively high content of protein. Poultry and pig diets can be characterised as indicated in Table B of WO 01/58275, columns 2-3. Fish diets can be characterised as indicated in column 4 of this Table B. Furthermore, such fish diets usually have a crude fat content of 200-310 g/kg.

An animal feed composition according to the invention has a crude protein content of 50-800 g/kg, and furthermore comprises one or more polypeptides having SOD activity as described herein.

Furthermore, or in the alternative (to the crude protein content indicated above), the animal feed composition of the invention has a content of metabolisable energy of 10-30 MJ/kg; and/or a content of calcium of 0.1-200 g/kg; and/or a content of available phosphorus of 0.1-200 g/kg; and/or a content of methionine of 0.1-100 g/kg; and/or a content of methionine plus cysteine of 0.1-150 g/kg; and/or a content of lysine of 0.5-50 g/kg.

In particular embodiments, the content of metabolisable energy, crude protein, calcium, phosphorus, methionine, methionine plus cysteine, and/or lysine is within any one of ranges 2, 3, 4 or 5 in Table B of WO 01/58275 (R. 2-5).

Crude protein is calculated as nitrogen (N) multiplied by a factor 6.25, i.e. Crude protein (g/kg)=N (g/kg)×6.25. The nitrogen content is determined by the Kjeldahl method (A.O.A.C., 1984, Official Methods of Analysis 14th ed., Association of Official Analytical Chemists, Washington DC).

Metabolisable energy can be calculated on the basis of the NRC publication Nutrient requirements in swine, ninth revised edition 1988, subcommittee on swine nutrition, committee on animal nutrition, board of agriculture, national research council. National Academy Press, Washington, D.C., pp. 2-6, and the European Table of Energy Values for Poultry Feed-stuffs, Spelderholt centre for poultry research and extension, 7361 DA Beekbergen, The Netherlands. Grafisch bedrijf Ponsen & looijen by, Wageningen. ISBN 90-71463-12-5.

The dietary content of calcium, available phosphorus and amino acids in complete animal diets is calculated on the basis of feed tables such as Veevoedertabel 1997, gegevens over chemische samenstelling, verteerbaarheid en voederwaarde van voedermiddelen, Central Veevoederbureau, Runderweg 6, 8219 pk Lelystad. ISBN 90-72839-13-7.

In a particular embodiment, the animal feed composition of the invention contains at least one vegetable protein as defined above.

The animal feed composition of the invention may also contain animal protein, such as Meat and Bone Meal, Feather meal, and/or Fish Meal, typically in an amount of 0-25%. The animal feed composition of the invention may also comprise Dried Distillers Grains with Solubles (DDGS), typically in amounts of 0-30%.

In still further particular embodiments, the animal feed composition of the invention contains 0-80% maize; and/or 0-80% sorghum; and/or 0-70% wheat; and/or 0-70% Barley; and/or 0-30% oats; and/or 0-40% soybean meal; and/or 0-25% fish meal; and/or 0-25% meat and bone meal; and/or 0-20% whey.

The animal feed may comprise vegetable proteins. In particular embodiments, the protein content of the vegetable proteins is at least 10, 20, 30, 40, 50, 60, 70, 80, or 90% (w/w). Vegetable proteins may be derived from vegetable protein sources, such as legumes and cereals, for example, materials from plants of the families Fabaceae (Leguminosae), Cruciferaceae, Chenopodiaceae, and Poaceae, such as soy bean meal, lupin meal, rapeseed meal, and combinations thereof.

In a particular embodiment, the vegetable protein source is material from one or more plants of the family Fabaceae, e.g., soybean, lupine, pea, or bean. In another particular embodiment, the vegetable protein source is material from one or more plants of the family Chenopodiaceae, e.g. beet, sugar beet, spinach or quinoa. Other examples of vegetable protein sources are rapeseed, and cabbage. In another particular embodiment, soybean is a preferred vegetable protein source. Other examples of vegetable protein sources are cereals such as barley, wheat, rye, oat, maize (corn), rice, and sorghum.

Animal diets can e.g. be manufactured as mash feed (non-pelleted) or pelleted feed. Typically, the milled feed-stuffs are mixed and sufficient amounts of essential vitamins and minerals are added according to the specifications for the species in question. Enzymes can be added as solid or liquid enzyme formulations. For example, for mash feed a solid or liquid enzyme formulation may be added before or during the ingredient mixing step. For pelleted feed the (liquid or solid) SOD/enzyme preparation may also be added before or during the feed ingredient step. Typically a liquid enzyme preparation comprises the SOD of the invention optionally with a polyol, such as glycerol, ethylene glycol or propylene glycol, and is added after the pelleting step, such as by spraying the liquid formulation onto the pellets. The SOD may also be incorporated in a feed additive or premix.

In an embodiment, the composition comprises one or more additional enzymes. In an embodiment, the composition comprises one or more microbes. In an embodiment, the composition comprises one or more vitamins. In an embodiment, the composition comprises one or more minerals. In an embodiment, the composition comprises one or more amino acids. In an embodiment, the composition comprises one or more other feed ingredients.

In another embodiment, the composition comprises one or more of the polypeptides of the invention, one or more formulating agents and one or more additional enzymes. In an embodiment, the composition comprises one or more of the polypeptides of the invention, one or more formulating agents and one or more microbes. In an embodiment, the composition comprises one or more of the polypeptides of the invention, one or more formulating agents and one or more vitamins. In an embodiment, the composition comprises one or more of the polypeptides of the invention and one or more minerals. In an embodiment, the composition comprises the polypeptide of the invention, one or more formulating agents and one or more amino acids. In an embodiment, the composition comprises one or more of the polypeptides of the invention, one or more formulating agents and one or more other feed ingredients.

In a further embodiment, the composition comprises one or more of the polypeptides of the invention, one or more formulating agents and one or more components selected from the list consisting of: one or more additional enzymes; one or more microbes; one or more vitamins; one or more minerals; one or more amino acids; and one or more other feed ingredients.

The final catalase concentration in the diet is within the range of 100 to 1000 mg enzyme protein per kg animal feed, such as 200 to 900 mg, 300 to 800 mg, 400 to 700 mg, 500 to 600 mg enzyme protein per kg animal feed, or any combination of these intervals.

The final catalase concentration in the diet can also be determined in Units/kg feed, which is within the range of 100 to 3000 Units per kg animal feed, such as 200 to 3000 U/kg, 300 to 2000 U/kg, 100 to 800 U/kg, 100 to 400 U/kg, or any combination of these intervals.

In another embodiment, the compositions described herein optionally include one or more enzymes for improving feed digestibility. Enzymes can be classified on the basis of the handbook Enzyme Nomenclature from NC-IUBMB, 1992), see also the ENZYME site at the internet: http://www.expasy.ch/enzyme/. ENZYME is a repository of information relative to the nomenclature of enzymes. It is primarily based on the recommendations of the Nomenclature Committee of the International Union of Biochemistry and Molecular Biology (IUB-MB), Academic Press, Inc., 1992, and it describes each type of characterized enzyme for which an EC (Enzyme Commission) number has been provided (Bairoch A. The ENZYME database, 2000, Nucleic Acids Res 28:304-305). This IUB-MB Enzyme nomenclature is based on their substrate specificity and occasionally on their molecular mechanism; such a classification does not reflect the structural features of these enzymes.

Thus the composition of the invention may also comprise at least one other enzyme selected from the group comprising of acetylxylan esterase (EC 3.1.1.23), acylglycerol lipase (EC 3.1.1.72), alpha-amylase (EC 3.2.1.1), beta-amylase (EC 3.2.1.2), arabinofuranosidase (EC 3.2.1.55), cellobiohydrolases (EC 3.2.1.91), cellulase (EC 3.2.1.4), feruloyl esterase (EC 3.1.1.73), galactanase (EC 3.2.1.89), alpha-galactosidase (EC 3.2.1.22), beta-galactosidase (EC 3.2.1.23), beta-glucanase (EC 3.2.1.6), beta-glucosidase (EC 3.2.1.21), triacylglycerol lipase (EC 3.1.1.3), lysophospholipase (EC 3.1.1.5), alpha-mannosidase (EC 3.2.1.24), beta-mannosidase (mannanase) (EC 3.2.1.25), phytase (EC 3.1.3.8, EC 3.1.3.26, EC 3.1.3.72), phospholipase A1 (EC 3.1.1.32), phospholipase A2 (EC 3.1.1.4), phospholipase D (EC 3.1.4.4), pullulanase (EC 3.2.1.41), pectinesterase (EC 3.1.1.11), beta-xylosidase (EC 3.2.1.37), or any combination thereof.

In another embodiment, the animal feed may include one or more vitamins, such as one or more fat-soluble vitamins and/or one or more water-soluble vitamins. In another embodiment, the animal feed may optionally include one or more minerals, such as one or more trace minerals and/or one or more macro minerals.

Usually fat- and water-soluble vitamins, as well as trace minerals form part of a so-called premix intended for addition to the feed, whereas macro minerals are usually separately added to the feed.

Non-limiting examples of fat-soluble vitamins include vitamin A, vitamin D3, vitamin E, and vitamin K, e.g., vitamin K3.

Non-limiting examples of water-soluble vitamins include vitamin C, vitamin B12, biotin and choline, vitamin B1, vitamin B2, vitamin B6, niacin, folic acid and panthothenate, e.g., Ca-D-panthothenate.

Non-limiting examples of trace minerals include boron, cobalt, chloride, chromium, copper, fluoride, iodine, iron, manganese, molybdenum, iodine, selenium and zinc.

Non-limiting examples of macro minerals include calcium, magnesium, phosphorus, potassium and sodium.

In one embodiment, the amount of vitamins is 0.001% to 10% by weight of the composition. In one embodiment, the amount of minerals is 0.001% to 10% by weight of the composition.

The nutritional requirements of these components (exemplified with poultry and piglets/pigs) are listed in Table A of WO 01/58275. Nutritional requirement means that these components should be provided in the diet in the concentrations indicated.

In the alternative, the animal feed additive of the invention comprises at least one of the individual components specified in Table A of WO 01/58275. At least one means either of, one or more of, one, or two, or three, or four and so forth up to all thirteen, or up to all fifteen individual components. More specifically, this at least one individual component is included in the additive of the invention in such an amount as to provide an in-feed-concentration within the range indicated in column four, or column five, or column six of Table A.

In a still further embodiment, the animal feed additive of the invention comprises at least one of the below vitamins, preferably to provide an in-feed-concentration within the ranges specified in the below Table 1 (for piglet diets, and broiler diets, respectively).

In the suitable embodiments, the invention relates to an animal feed and a method of improving one or more performance parameters in an animal comprising administering to the animal an animal feed or animal feed additive comprising one or more polypeptides having catalase activity, wherein the one or more performance parameters is selected from the group consisting of the European Production Efficiency Factor (EPEF), Feed Conversion Ratio (FCR), Growth Rate (GR), Body Weight Gain (WG), Mortility Rate (MR) and Flock Uniformity (FU).

These features are supported by examples 1 2, 3, and 4. As it is generally known, an improved FCR is lower than the control FCR. In particular embodiments, the FCR is improved (i.e., reduced) as compared to the control by at least 1.0%, preferably at least 1.5%, 1.6%, 1.7%, 1.8%, 1.9%, 2.0%, 2.1%, 2.2%, 2.3%, 2.4%, or at least 2.5%.

The term “mortality” as used herein refers to the ratio of life animals at the end of the growth phase versus the number of animals originally included into the pond. It may be determined on the basis of a fish challenge trial comprising two groups of fish challenged by a particular fish pathogen with the aim to provoke a mortality of 40 to 80% of the animals in the untreated group. However, in the challenge group fed with a suitable concentration per Kg of feed of a mixture of at least two compounds according to the invention, the mortality is reduced compared to the untreated group by at least 5%, preferably at least, 10%, 15%, 20%, 25%, 30%, 35%, 40%, 45%, or at least 50%.

TABLE 1
Typical vitamin recommendations

| Vitamin | Piglet diet | | Broiler diet | |
|---|---|---|---|---|
| Vitamin A | 10,000-15,000 | IU/kg feed | 8-12,500 | IU/kg feed |
| Vitamin D3 | 1800-2000 | IU/kg feed | 3000-5000 | IU/kg feed |
| Vitamin E | 60-100 | mg/kg feed | 150-240 | mg/kg feed |
| Vitamin K3 | 2-4 | mg/kg feed | 2-4 | mg/kg feed |
| Vitamin B1 | 2-4 | mg/kg feed | 2-3 | mg/kg feed |
| Vitamin B2 | 6-10 | mg/kg feed | 7-9 | mg/kg feed |
| Vitamin B6 | 4-8 | mg/kg feed | 3-6 | mg/kg feed |
| Vitamin B12 | 0.03-0.05 | mg/kg feed | 0.015-0.04 | mg/kg feed |
| Niacin | 30-50 | mg/kg feed | 50-80 | mg/kg feed |
| (Vitamin B3) | | | | |
| Pantothenic | 20-40 | mg/kg feed | 10-18 | mg/kg feed |
| acid | | | | |
| Folic acid | 1-2 | mg/kg feed | 1-2 | mg/kg feed |
| Biotin | 0.15-0.4 | mg/kg feed | 0.15-0.3 | mg/kg feed |
| Choline | 200-400 | mg/kg feed | 300-600 | mg/kg feed |
| chloride | | | | |

In some embodiments, the invention relates to an animal feed and a method of improving or enhancing immune response and/or reducing inflammation and/or for the modulation of the gut flora in an animal comprising administering to the animal an animal feed or animal feed additive comprising one or more polypeptides having superoxide dismutase activity.

These features are supported by example 1 as the first two features are very much linked to oxidative stress. Different in-vitro models tested by the applicant also show that SODs optionally in combinations with a catalase are very effective to decrease oxidative stress/burst.

Dysregulating effects of heat stress and oxidative stress also help in maintaining gut integrity and function. Therefore, the invention also supports a positive modulation of the gut flora, in particular of the microbial gut flora.

The term “gut” as used herein designates the gastrointestinal or digestive tract (also referred to as the alimentary canal) and it refers to the system of organs within multi-cellular animals which takes in food, digests it to extract energy and nutrients, and expels the remaining waste.

The term gut “microflora” as used herein refers to the natural microbial cultures residing in the gut and maintaining health by aiding in proper digestion.

The term “modulate” as used herein in connection with the gut microflora generally means to change, manipulate, alter, or adjust the function or status thereof in a healthy and normally functioning animal, i.e. a non-therapeutic use.

The term “supporting immune system function” as used herein refers to the immune stimulation effect obtained by the compounds according to the invention.

In the fifth and sixth embodiment, the invention relates to a method of reducing or eliminating the use of antibiotics administered to animal feed or to a method of reducing cellular markers of reactive oxygen species or free radicals in animal body comprising administering to the animal an animal feed or animal feed additive comprising one or more polypeptides having catalase activity. These embodiments are supported by examples 1 to 4.

In the seventh embodiment, the invention relates to an animal feed additive or animal feed premix comprising one or more polypeptides having superoxide dismutase (SOD), wherein the feed additive or premix further comprises
one or more polypeptides having catalase activity and/or
one or more vitamins, wherein the one or more vitamins is preferably a fat-soluble vitamin, for example vitamin E.

As shown in example 1, such a premix has strong antioxidative properties and can be used, optionally in combination with selenium as an antioxidant in feed and feed premixes or as a replacement or partial replacement of antibiotics in animal feed.

The protein source of the animal feed is selected from the group consisting of soybean, wild soybean, beans, lupin, tepary bean, scarlet runner bean, slimjim bean, lima bean, French bean, Broad bean (fava bean), chickpea, lentil, peanut, Spanish peanut, canola, sunflower seed, cotton seed, rapeseed (oilseed rape) or pea or in a processed form such as soybean meal, full fat soy bean meal, soy protein concentrate (SPC), fermented soybean meal (FSBM), sunflower meal, cotton seed meal, rapeseed meal, fish meal, bone meal, feather meal, whey or any combination thereof.

The energy source of the animal feed is selected from the group consisting of maize, corn, sorghum, barley, wheat, oats, rice, triticale, rye, beet, sugar beet, spinach, potato, cassava, quinoa, cabbage, switchgrass, millet, pearl millet, foxtail millet or in a processed form such as milled corn, milled maize, potato starch, cassava starch, milled sorghum, milled switchgrass, milled millet, milled foxtail millet, milled pearl millet, or any combination thereof.

In a preferred example, the animal feed further comprises one or more components selected from the list consisting of one or more additional enzymes; one or more microbes; one or more vitamins; one or more minerals; one or more amino acids; and one or more other feed ingredients, as described herein.

In a further embodiment, the invention relates to an animal feed additive or animal feed premix comprising one or more polypeptides having catalase activity, wherein the feed additive or premix further comprises
d. one or more polypeptides having superoxide dismutase activity and/or
e. one or more vitamins, wherein the one or more vitamins is preferably a fat-soluble vitamin, for example vitamin E.

A preferred example of the catalase according to the invention is a polypeptide having at least 80% sequence identity to SEQ ID NO: 1 and SEQ ID NO: 2, SEQ ID NO: 3 and SEQ ID NO 4, SEQ ID NO: 5 and SEQ ID NO: 6.

A preferred animal feed premix (animal feed additive) comprises one or more polypeptides having catalase activity, vitamin E and optionally selenium and is used as antioxidant, preferably in feed and feed premixes or as a replacement or partial replacement of antibiotics in animal feed.

Examples of commercial vitamin E and selenium are Rovimix®E50 and SePlex (DSM Nutritional Products).

### Enzyme Formulation

The polypeptide having catalase activity of the invention may be formulated as a liquid or a solid. For a liquid formulation, the formulating agent may comprise a polyol (such as e.g. glycerol, ethylene glycol or propylene glycol), a salt (such as e.g. sodium chloride, sodium benzoate, potassium sorbate) or a sugar or sugar derivative (such as e.g. dextrin, glucose, sucrose, and sorbitol). Thus, in one embodiment, the composition is a liquid composition comprising the polypeptide of the invention and one or more formulating agents selected from the list consisting of glycerol, ethylene glycol, 1,2-propylene glycol, 1,3-propylene glycol, sodium chloride, sodium benzoate, potassium sorbate, dextrin, glucose, sucrose, and sorbitol. The liquid formulation may be sprayed onto the feed after it has been pelleted or may be added to drinking water given to the animals.

In one embodiment, the liquid formulation further comprises 20%-80% polyol (i.e. total amount of polyol), preferably 25%-75% polyol, more preferably 30%-70% polyol, more preferably 35%-65% polyol or most preferably 40%-60% polyol. In one embodiment, the liquid formulation comprises 20%-80% polyol, preferably 25%-75% polyol, more preferably 30%-70% polyol, more preferably 35%-65% polyol or most preferably 40%-60% polyol wherein the polyol is selected from the group consisting of glycerol, sorbitol, propylene glycol (MPG), ethylene glycol, diethylene glycol, triethylene glycol, 1, 2-propylene glycol or 1, 3-propylene glycol, dipropylene glycol, polyethylene glycol (PEG) having an average molecular weight below about 600 and polypropylene glycol (PPG) having an average molecular weight below about 600. In one embodiment, the liquid formulation comprises 20%-80% polyol (i.e. total amount of polyol), preferably 25%-75% polyol, more preferably 30%-70% polyol, more preferably 35%-65% polyol or most preferably 40%-60% polyol wherein the polyol is selected from the group consisting of glycerol, sorbitol and propylene glycol (MPG).

In one embodiment, the liquid formulation further comprises preservative, preferably selected from the group consisting of sodium sorbate, potassium sorbate, sodium benzoate and potassion benzoate or any combination thereof. In one embodiment, the liquid formulation comprises 0.02% to 1.5% w/w preservative, more preferably 0.05% to 1.0% w/w preservative or most preferably 0.1% to 0.5% w/w preservative. In one embodiment, the liquid formulation comprises 0.001% to 2.0% w/w preservative (i.e. total amount of preservative), preferably 0.02% to 1.5% w/w preservative, more preferably 0.05% to 1.0% w/w preservative or most preferably 0.1% to 0.5% w/w preservative wherein the preservative is selected from the group consisting of sodium sorbate, potassium sorbate, sodium benzoate and potassium benzoate or any combination thereof.

For a solid formulation, the formulation may be for example as a granule, spray dried powder or agglomerate (e.g. as disclosed in WO2000/70034). The formulating agent may comprise a salt (organic or inorganic zinc, sodium, potassium or calcium salts such as e.g. such as calcium acetate, calcium benzoate, calcium carbonate, calcium chloride, calcium citrate, calcium sorbate, calcium sulfate, potassium acetate, potassium benzoate, potassium carbonate, potassium chloride, potassium citrate, potassium sorbate, potassium sulfate, sodium acetate, sodium benzoate, sodium carbonate, sodium chloride, sodium citrate, sodium sulfate, zinc acetate, zinc benzoate, zinc carbonate, zinc chloride, zinc citrate, zinc sorbate, zinc sulfate), starch or a sugar or sugar derivative (such as e.g. sucrose, dextrin, glucose, lactose, sorbitol).

In one embodiment, the composition is a solid composition, such as a spray dried composition, comprising the polypeptide having catalase activity of the invention and one or more formulating agents selected from the list consisting of sodium chloride, sodium benzoate, potassium sorbate, sodium sulfate, potassium sulfate, magnesium sulfate, sodium thiosulfate, calcium carbonate, sodium citrate, dextrin, glucose, sucrose, sorbitol, lactose, starch and cellulose. In a preferred embodiment, the formulating agent is selected from one or more of the following compounds: sodium sulfate, dextrin, cellulose, sodium thiosulfate, magnesium sulfate and calcium carbonate.

The present invention also relates to enzyme granules/particles comprising the polypeptide having catalase activity of the invention optionally combined with one or more additional enzymes. The granule is composed of a core, and optionally one or more coatings (outer layers) surrounding the core.

Typically, the granule/particle size, measured as equivalent spherical diameter (volume based average particle size), of the granule is 20-2000 μm, particularly 50-1500 μm, 100-1500 μm or 250-1200 μm.

The core can be prepared by granulating a blend of the ingredients, e.g., by a method comprising granulation techniques such as crystallization, precipitation, pan-coating, fluid bed coating, fluid bed agglomeration, rotary atomization, extrusion, prilling, spheronization, size reduction methods, drum granulation, and/or high shear granulation.

Methods for preparing the core can be found in Handbook of Powder Technology; Particle size enlargement by C. E. Capes; Volume 1; 1980; Elsevier. Preparation methods include known feed and granule formulation technologies, e.g.:
a) spray dried products, wherein a liquid enzyme-containing solution is atomized in a spray drying tower to form small droplets which during their way down the drying tower dry to form an enzyme-containing particulate material;
b) layered products, wherein the enzyme is coated as a layer around a pre-formed inert core particle, wherein an enzyme-containing solution is atomized, typically in a fluid bed apparatus wherein the pre-formed core particles are fluidized, and the enzyme-containing solution adheres to the core particles and dries up to leave a layer of dry enzyme on the surface of the core particle. Particles of a desired size can be obtained this way if a useful core particle of the desired size can be found. This type of product is described in, e.g., WO 97/23606;
c) absorbed core particles, wherein rather than coating the enzyme as a layer around the core, the enzyme is absorbed onto and/or into the surface of the core. Such a process is described in WO 97/39116.
d) extrusion or pelletized products, wherein an enzyme-containing paste is pressed to pellets or under pressure is extruded through a small opening and cut into particles which are subsequently dried. Such particles usually have a considerable size because of the material in which the extrusion opening is made (usually a plate with bore holes) sets a limit on the allowable pressure drop over the extrusion opening. Also, very high extrusion pressures when using a small opening increase heat generation in the enzyme paste, which is harmful to the enzyme;
e) prilled products, wherein an enzyme-containing powder is suspended in molten wax and the suspension is sprayed, e.g., through a rotating disk atomiser, into a cooling chamber where the droplets quickly solidify (Michael S. Showell (editor); Powdered detergents; Surfactant Science Series; 1998; vol. 71; page 140-142; Marcel Dekker). The product obtained is one wherein the enzyme is uniformly distributed throughout an inert material instead of being concentrated on its surface. Also U.S. Pat. Nos. 4,016,040 and 4,713,245 are documents relating to this technique;
f) mixer granulation products, wherein a liquid is added to a dry powder composition of, e.g., conventional granulating components, the enzyme being introduced either via the liquid or the powder or both. The liquid and the powder are mixed and as the moisture of the liquid is absorbed in the dry powder, the components of the dry powder will start to adhere and agglomerate and particles will build up, forming granulates comprising the enzyme. Such a process is described in U.S. Pat. No. 4,106,991 and related documents EP 170360, EP 304332, EP 304331, WO 90/09440 and WO 90/09428. In a particular product of this process wherein various high-shear mixers can be used as granulators, granulates consisting of enzyme as enzyme, fillers and binders etc. are mixed with cellulose fibres to reinforce the particles to give the so-called T-granulate. Reinforced particles, being more robust, release less enzymatic dust.
g) size reduction, wherein the cores are produced by milling or crushing of larger particles, pellets, tablets, briquettes etc. containing the enzyme. The wanted core particle fraction is obtained by sieving the milled or crushed product. Over and undersized particles can be recycled. Size reduction is described in (Martin Rhodes (editor); Principles of Powder Technology; 1990; Chapter 10; John Wiley & Sons);
h) fluid bed granulation, which involves suspending particulates in an air stream and spraying a liquid onto the fluidized particles via nozzles. Particles hit by spray droplets get wetted and become tacky. The tacky particles collide with other particles and adhere to them and form a granule;
i) the cores may be subjected to drying, such as in a fluid bed drier. Other known methods for drying granules in the feed or detergent industry can be used by the skilled person. The drying preferably takes place at a product temperature of from 25 to 90° C. For some enzymes it is important the cores comprising the enzyme contain a low amount of water before coating. If water sensitive enzymes are coated before excessive water is removed, it will be trapped within the core and it may affect the activity of the enzyme negatively. After drying, the cores preferably contain 0.1-10 c/o w/w water.

The core may include additional materials such as fillers, fibre materials (cellulose or synthetic fibres), stabilizing agents, solubilizing agents, suspension agents, viscosity regulating agents, light spheres, plasticizers, salts, lubricants and fragrances.

The core may include a binder, such as synthetic polymer, wax, fat, or carbohydrate.

The core may include a salt of a multivalent cation, a reducing agent, an antioxidant, a peroxide decomposing catalyst and/or an acidic buffer component, typically as a homogenous blend.

In one embodiment, the core comprises a material selected from the group consisting of salts (such as calcium acetate, calcium benzoate, calcium carbonate, calcium chloride, calcium citrate, calcium sorbate, calcium sulfate, potassium acetate, potassium benzoate, potassium carbonate, potassium chloride, potassium citrate, potassium sorbate, potassium sulfate, sodium acetate, sodium benzoate, sodium carbonate, sodium chloride, sodium citrate, sodium sulfate, zinc acetate, zinc benzoate, zinc carbonate, zinc chloride, zinc citrate, zinc sorbate, zinc sulfate), starch or a sugar or sugar derivative (such as e.g. sucrose, dextrin, glucose, lactose, sorbitol), sugar or sugar derivative (such as e.g. sucrose, dextrin, glucose, lactose, sorbitol), small organic molecules, starch, flour, cellulose and minerals and clay minerals (also known as hydrous aluminium phyllosilicates). In one embodiment, the core comprises a clay mineral such as kaolinite or kaolin.

The core may include an inert particle with the enzyme absorbed into it, or applied onto the surface, e.g., by fluid bed coating.

The core may have a diameter of 20-2000 μm, particularly 50-1500 μm, 100-1500 μm or 250-1200 μm.

The core may be surrounded by at least one coating, e.g., to improve the storage stability, to reduce dust formation during handling, or for coloring the granule. The optional coating(s) may include a salt and/or wax and/or flour coating, or other suitable coating materials.

The coating may be applied in an amount of at least 0.1% by weight of the core, e.g., at least 0.5%, 1% or 5%. The amount may be at most 100%, 70%, 50%, 40% or 30%.

The coating is preferably at least 0.1 μm thick, particularly at least 0.5 μm, at least 1 μm or at least 5 μm. In some embodiments the thickness of the coating is below 100 μm, such as below 60 μm, or below 40 μm.

The coating should encapsulate the core unit by forming a substantially continuous layer. A substantially continuous layer is to be understood as a coating having few or no holes, so that the core unit is encapsulated or enclosed with few or no uncoated areas. The layer or coating should in particular be homogeneous in thickness.

The coating can further contain other materials as known in the art, e.g., fillers, antisticking agents, pigments, dyes, plasticizers and/or binders, such as titanium dioxide, kaolin, calcium carbonate or talc.

The granule may comprise a core comprising the polypeptide having catalase activity of the invention, one or more salt coatings and one or more wax coatings. Examples of enzyme granules with multiple coatings are shown in WO1993/07263, WO1997/23606 and WO2016/149636.

A salt coating may comprise at least 60% by weight of a salt, e.g., at least 65%, at least 70%, at least 75%, at least 80%, at least 85%, at least 90%, at least 95% or at least 99% by weight.

The salt may be added from a salt solution where the salt is completely dissolved or from a salt suspension wherein the fine particles are less than 50 μm, such as less than 10 μm or less than 5 μm.

The salt coating may comprise a single salt or a mixture of two or more salts. The salt may be water soluble, in particular having a solubility at least 0.1 g in 100 g of water at 20° C., preferably at least 0.5 g per 100 g water, e.g., at least 1 g per 100 g water, e.g., at least 5 g per 100 g water.

The salt may be an inorganic salt, e.g., salts of sulfate, sulfite, phosphate, phosphonate, nitrate, chloride or carbonate or salts of simple organic acids (less than 10 carbon atoms, e.g., 6 or less carbon atoms) such as citrate, malonate or acetate. Examples of cations in these salts are alkali or earth alkali metal ions, the ammonium ion or metal ions of the first transition series, such as sodium, potassium, magnesium, calcium, zinc or aluminium. Examples of anions include chloride, bromide, iodide, sulfate, sulfite, bisulfite, thiosulfate, phosphate, monobasic phosphate, dibasic phosphate, hypophosphite, dihydrogen pyrophosphate, tetraborate, borate, carbonate, bicarbonate, metasilicate, citrate, malate, maleate, malonate, succinate, sorbate, lactate, formate, acetate, butyrate, propionate, benzoate, tartrate, ascorbate or gluconate. In particular alkali- or earth alkali metal salts of sulfate, sulfite, phosphate, phosphonate, nitrate, chloride or carbonate or salts of simple organic acids such as citrate, malonate or acetate may be used.

The salt in the coating may have a constant humidity at 20° C. above 60%, particularly above 70%, above 80% or above 85%, or it may be another hydrate form of such a salt (e.g., anhydrate). The salt coating may be as described in WO1997/05245, WO1998/54980, WO1998/55599, WO2000/70034, WO2006/034710, WO2008/017661, WO2008/017659, WO2000/020569, WO2001/004279, WO1997/05245, WO2000/01793, WO2003/059086, WO2003/059087, WO2007/031483, WO2007/031485, WO2007/044968, WO2013/192043, WO2014/014647 and WO2015/197719 or polymer coating such as described in WO 2001/00042.

Specific examples of suitable salts are NaCl (CH20° C.=76%), Na2CO3 (CH20° C.=92%), NaNO3 (CH20° C.=73%), Na2HPO4 (CH20° C.=95%), Na3PO4 (CH25° C.=92%), NH4CI (CH20° C.=79.5%), (NH4)₂HPO4 (CH20° C.=93.0%), NH4H2PO4 (CH20° C.=93.1%), (NH4)₂SO₄ (CH20° C.=81.1%), KCl (CH20° C.=85%), K2HPO4 (CH20° C.=92%), KH2PO4 (CH20° C.=96.5%), KNO3 (CH20° C.=93.5%), Na2SO4 (CH20° C.=93%), K2SO4 (CH20° C.=98%), KHSO4 (CH20° C.=86%), MgSO4 (CH20° C.=90%), ZnSO4 (CH20° C.=90%) and sodium citrate (CH25° C.=86%). Other examples include NaH2PO4, (NH4)H2PO4, CuSO4, Mg(NO3)₂, magnesium acetate, calcium acetate, calcium benzoate, calcium carbonate, calcium chloride, calcium citrate, calcium sorbate, calcium sulfate, potassium acetate, potassium benzoate, potassium carbonate, potassium chloride, potassium citrate, potassium sorbate, sodium acetate, sodium benzoate, sodium citrate, sodium sulfate, zinc acetate, zinc benzoate, zinc carbonate, zinc chloride, zinc citrate and zinc sorbate.

The salt may be in anhydrous form, or it may be a hydrated salt, i.e. a crystalline salt hydrate with bound water(s) of crystallization, such as described in WO 99/32595. Specific examples include anhydrous sodium sulfate (Na2SO4), anhydrous magnesium sulfate (MgSO4), magnesium sulfate heptahydrate (MgSO4.7H2O), zinc sulfate heptahydrate (ZnSO4.7H2O), sodium phosphate dibasic heptahydrate (Na2HPO4.7H2O), magnesium nitrate hexahydrate (Mg(NO3)2(6H2O)), sodium citrate dihydrate and magnesium acetate tetrahydrate.

Preferably the salt is applied as a solution of the salt, e.g., using a fluid bed.

A wax coating may comprise at least 60% by weight of a wax, e.g., at least 65%, at least 70%, at least 75%, at least 80%, at least 85%, at least 90%, at least 95% or at least 99% by weight.

Specific examples of waxes are polyethylene glycols; polypropylenes; Carnauba wax; Candelilla wax; bees wax; hydrogenated plant oil or animal tallow such as polyethylene glycol (PEG), methyl hydroxy-propyl cellulose (MHPC), polyvinyl alcohol (PVA), hydrogenated ox tallow, hydrogenated palm oil, hydrogenated cotton seeds and/or hydrogenated soy bean oil; fatty acid alcohols; mono-glycerides and/or di-glycerides, such as glyceryl stearate, wherein stearate is a mixture of stearic and palmitic acid; micro-crystalline wax; paraffin's; and fatty acids, such as hydrogenated linear long chained fatty acids and derivatives thereof. A preferred wax is palm oil or hydrogenated palm oil.

Non-dusting granulates may be produced, e.g., as disclosed in U.S. Pat. Nos. 4,106,991 and 4,661,452 and may optionally be coated by methods known in the art. The coating materials can be waxy coating materials and film-forming coating materials. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591.

The granulate may further comprise one or more additional enzymes. Each enzyme will then be present in more granules securing a more uniform distribution of the enzymes, and also reduces the physical segregation of different enzymes due to different particle sizes. Methods for producing multi-enzyme co-granulates is disclosed in the ip.com disclosure IPCOM000200739D.

### EXAMPLES

### Example 1 Catalase Cloning and Expression Strains

Escherichia coli Top-10 strain purchased from Invitrogen (Thermofisher Inc.) was used to propagate our expression vector.

Aspergillus oryzae strain MT3568 (described in WO2015040159) was used for heterologous expression of the genes described in Table 1.

### Media

DAP4C medium is composed of 11 g MgSO₄·7H₂O, 1 g KH2PO4, 2.2 g Citric acid·H₂O, 20 g glucose, 10 g maltose, 5.2 g K₃PO₄·H₂O, 0.5 g yeast extract, 1.25 g CaCO₃, 0.5 ml AMG Trace element solution and deionized water to 1 liter. After autoclaving, 3.3 ml of 20% Lactic Acid (autoclaved) and 9.3 ml of 50% (NH₄)₂HPO₄ (sterile filtered) are added to every 400 ml of the above medium.

AMG Trace element solution is composed of 6.8 g ZnCl₂, 2.5 g CuSO4.5H₂O, 0.24 g NiCl₂·5H₂O, 13.9 g FeSO₄.7H₂O, 13.6 g MnSO₄.5H₂O, 3 g Citric acid. H₂O, and deionised water to 1000 ml.

LB plates are composed of 10 g of Bacto-tryptone, 5 g of yeast extract, 10 g of sodium chloride, 15 g of Bacto-agar, and deionised water to 1000 ml.

LB medium is composed of 1 g of Bacto-tryptone, 5 g of yeast extract, and 10 g of sodium chloride, and deionised water to 1000 ml.

COVE sucrose plates are composed of 342 g of sucrose, 20 g of agar powder, 20 ml of COVE salt solution, and deionized water to 1 liter. The medium was sterilized by autoclaving. For the transformation of MT3568, 10 mM acetamide was added, when the medium was cooled to 60° C.

COVE-2 plate/tube for isolation if single transformants: 30 g/L sucrose, 20 ml/L COVE salt solution, 10 mM acetamide, 30 g/L noble agar (Difco, Cat #214220).

COVE salt solution is composed of 26 g of MgSO₄·7H₂O, 26 g of KCL, 26 g of KH₂PO₄, 50 ml of COVE trace metal solution, and deionised water to 1000 ml.

COVE trace metal solution is composed of 0.04 g of Na₂B₄O₇·10H₂O, 0.4 g of CuSO₄·5H₂O, 1.2 g of FeSO₄·7H₂O, 0.7 g of MnSO₄·H₂O, 0.8 g of Na2MoO₄·2H₂O, 10 g of ZnSO₄·7H₂O, and deionised water to 1000 ml.

### Example 2: Cloning, Expression and Fermentation of Fungal Catalase Enzymes

The catalase genes were derived from fungal strains isolated from environmental samples using standard microbiological isolation techniques. The donor strains HEAL7001, was identified, and taxonomy assigned based on the DNA sequencing of the ITS (Table 1). The donor fungal organism for HEAL7060 was Curvularia verruculosa, a publicly available strain originally isolated from a grass inflorescence in The Gambian Republic, Africa. The strain was originally collected in 1966: Curvularia verruculosa Tandon & Bilgrami ex M. B. Ellis, Mycological Papers 106: 20 (1966).

Chromosomal DNA from individual strains was isolated by QIAamp Dneasy Kit (Qiagen, Hilden, Germany). 5 μg of each genomic DNA sample were sent for full genome sequencing using Illumina technology. Genome sequencing, the subsequent assembly of reads and the gene discovery (i.e. annotation of gene functions) is known to persons skilled in the art and the service can also be purchased commercially.

The genome sequences were BLAST analyzed for putative catalase from the PFAM database families PF00199 and PF18011. This analysis identified genes encoding putative catalases, which were subsequently cloned and recombinantly expressed in Aspergillus oryzae.

The catalase genes were amplified by PCR respectively from above isolated genomic DNA. The purified PCR products were cloned into the previously digested pDau109 by ligation with an IN-FUSION™ CF Dry-down Cloning Kit (Clontech Laboratories, Inc., Mountain View, CA, USA) according to the manufacturer's instructions. The plasmid pDAu109 and its use are described in (WO 2005/042735). The ligation mixture was used to transform E. coli TOP10 chemically competent cells (described in Strains). The cloned genes were sequenced and confirmed to be identical to the corresponding genes found in the genome sequences and transformed into the Aspergillus oryzae strain MT3568 (WO 11/057140) by the methods described in Christensen et al., 1988, Biotechnology 6, 1419-1422 and WO 04/032648. Transformants were selected during regeneration from protoplasts based on the ability, conferred by a selectable marker in the expression vector, to utilize acetamide as a nitrogen source, and were subsequently re-isolated under selection.

Production of the recombinant catalase peptides was evaluated by culturing the transformants in 96-well deep-well microtiter plates for 4 days at 30° C. in either a 0.25 ml or 0.75 ml volume of either or both YPG medium (WO 05/066338) or DAP-4C-1 medium (WO 12/103350) and monitoring peptide expression by SDS-PAGE. A single Aspergillus transformant was selected for each gene based on expression yields as evaluated in microtiter plate fermentation.

Spores of the best expressed transformant were spread on COVE-2 plates for re-isolation in order to isolate single colonies. Then a single colony was spread on a COVE-2 tube until sporulation.

For larger-scale production of the recombinant enzymes, and the Aspergillus transformants were cultured in 500 ml baffled flasks containing 150 ml of fermentation medium. Transformants expressing the catalase peptides were fermented in DAP-4C-1 medium (WO 12/103350). The cultures were shaken on a rotary table at 150 RPM at for 4 days, and the broth was subsequently separated from cellular material by passage through a 0.22 um filtration unit.

### Example 3: Catalase Activity Assay

The catalase from Bovine Liver (Sigma®, Enzyme Commission (EC) Number: 1.11.1.6, CAS Number: 9001-05-2, Molecular weight: 250 kDa) has an activity of 3524 U/mg EP. Catalase activity was determined by H₂O₂ reduction detected at 240 nm. Firstly, catalase was diluted with different dilution times by MQ water and 0.01% Triton X-100. 10 μl enzyme sample, 90 μl activity buffer (K₂HPO₄/KH₂PO₄ mixed with final concentration of 100 mM PBS at pH7.0) were added into 50 μl 0.2% H₂O₂ solution (30% H₂O₂ was diluted to 0.2% in activity buffer). The mixture was measured at 240 nm for 10 minutes at room temperature (interval 34 sec, shake before first read). The commercial catalase from Sigma®, catalase from bovine liver (C1345), was set as reference. This allows for the selection of the suitable enzyme dosage.

| | Mature | |
|---|---|---|
| | polypeptide | Relative Activity |
| Source | SEQ ID NO | U/mg EP |
| Talaromyces stipitatus | SEQ ID NO 10 | 1667 |
| Penicillium emersonii | SEQ ID NO 13 | 8265 |
| Penicillium oxalicum | SEQ ID NO 21 | 30953 |
| Thermoascus crustaceus | SEQ ID NO 23 | 10919 |
| Thermothelomyces thermophilus | SEQ ID NO 17 | 18314 |
| Curvularia verruculosa | SEQ ID NO 18 | 20836 |
| Aspergillus oryzae | SEQ ID NO 20 | 43975 |
| Aspergillus lentulus | SEQ ID NO 9 | 52327 |
| Aspergillus fumigatus | SEQ ID NO 16 | 51648 |
| Neurospora crassa | SEQ ID NO 27 | 8651 |
| Malbranchea cinnamomea | SEQ ID NO 11 | 82637 |
| Humicola hyalothermophila | SEQ ID NO 22 | 56454 |
| Thielavia australiensis | SEQ ID NO 24 | 5273 |
| Thermomucor indicae-seudaticae | SEQ ID NO 15 | 7750 |
| Crassicarpon thermophilum | SEQ ID NO 12 | 39459 |

### Example 4: Gastric Stability Assay for Catalase

Gastric stability was assayed with artificial gastric juice as stress condition. 10 μl catalase with appropriate dilution was added into 90 μl stress buffer (100 mM NaCl, 0.0013M HCl at pH3.0). The stress buffer with pepsin was prepared by adding 1.11 mg/ml pepsin (from porcine gastric mucosa, P7000, Sigma, 474U/mg) as pH3+pepsin buffer, and also was incubated with 10 μl catalase. The mixture was incubated at 37° C. in thermomixer for 0, 30, 60 and 90 minutes separately. 10 μl sample extracted from the mixture was added into 90 μl activity buffer as stop mixture. Then 100 μl stop mixture was added with 50 μl 0.2% H₂O₂ solution to measure absorbance. The absorbance was measured at 240 nm for 10 minutes at room temperature (interval 34 sec, shake before first read). One slop could be calculated by OD vs min, which presents the activity. The activity at pH7.0 without stress condition was set as reference, and the residual activity at stress condition (pH3.0 or pH3.0+pepsin) compared with reference was calculated as relative stability.

| | Gastric stability: pH 3, +pepsin |
|---|---|
| Catalase SEQ ID NO | 30 min − residual value % |
| SEQ ID NO 14 | 55 |
| SEQ ID NO 8 | 85 |
| SEQ ID NO 1 | 95 |
| SEQ ID NO 10 | 97 |
| SEQ ID NO 13 | 85 |
| SEQ ID NO 21 | 98 |
| SEQ ID NO 11 | 81 |
| SEQ ID NO 17 | 97 |
| SEQ ID NO 20 | 77 |
| SEQ ID NO 9 | 82 |
| SEQ ID NO 16 | 46 |
| SEQ ID NO 22 | 97 |
| SEQ ID NO 12 | 100 |
| SEQ ID NO 15 | 100 |
| SEQ ID NO 27 | 100 |

### Example 5: Preventing Oxidation of Vitamins

Comparison of the ROS Disarming Efficiency by the Oxidoreductase Enzymes SOD and CAT Compared to Trolox

### Experiment: Comparison of SOD and Trolox

To compare the superoxide disarming efficiency of SOD compared to Trolox, we prepared a series of samples with a dose-response for Trolox, a dose-response for SOD or a dose-response combination of the two. We used a competitive assay to measure the efficiency of either Trolox, SOD or a combination of the two to disarm superoxide (generated by hypoxanthine and xanthine oxidase, see Error! Reference source not found.). The remaining superoxide is quantified by the radical indicator WST-1, which forms a formazan upon reaction with superoxide. This formazan absorbs at 450 nm.

### Data Evaluation: Comparison of SOD and Trolox

For each well, the absorption was measured at 450 nm over time using the competitive assay outlined in Error! Reference source not found. For the kinetic measurement of each well (only a dose-response subset for the NZ standard shown for ease in Error! Reference source not found. A), the slope is determined and plotted as a function of the enzyme dose, i.e. concentration or activity (Error! Reference source not found. B). A logistic 4 parametric function was used in SAS JMP16 to fit the logistic function to the data. This function was used to calculate the amount of SOD necessary in order to reach the same slope as for a given Trolox sample in the assay (Error! Reference source not found. C). The slope of the linear part in Error! Reference source not found. C describes how many grams of Trolox equivalents a mg or Unit of enzyme contains. This procedure was performed for all SOD candidates and the Trolox equivalents for a mg or unit of enzyme calculated for all SOD candidates.

Kinetic measurements for the standard, where Abs at 450 nm is measured as a function of time. The obtained slopes are plotted as a function of the enzyme dose (mg or units). A 4 parametric logistic function was used to describe the data. The amount of SOD to reach the same competition for superoxide as a given amount of Trolox was calculated using this function and this relationship. The slope of this graph of the linear part describes how many grams of Trolox equivalents a mg or Unit of enzyme contains.

TABLE 1
Trolox equivalents for SOD and CAT enzymes.

| | Specific | Protein | | | molecules | molecules |
|---|---|---|---|---|---|---|
| | activity | concentration | MW | | Trolox/molecules | Trolox/molecules |
| Enzyme | (U/μgEP) | (mgEP/mL) | (g/mol) | mg Trolox/mgEP) | Enzyme) | Enzyme) |
| SEQ ID NO 28 | | | 18000 | | | |
| SEQ ID NO 29 | 2.1250 | 1 | 30000 | 17713 | 2125582 | 142146 |
| SEQ ID NO 30 | 1.9700 | 8 | 20000 | 4676 | 374049 | 20299 |
| SEQ ID NO 31 | 2.8267 | 1 | 20000 | 32375 | 2590027 | 169771 |
| SEQ ID NO 28 | 0.5497 | 13 | 18000 | 736 | 53028 | 1310 |
| standard | 0.4198 | | 30000 | 180 | 21560 | 348 |
| Trolox | | | 250 | 1 | 1 | 0 |
| HEAL7009-4 | 25 | 98 | 76754 | 1187 | 364339 | 23233 |

Experiment: Comparison of CAT and Trolox

To compare the hydrogen peroxide disarming efficiency of CAT compared to Trolox, we prepared a series of samples with a dose-response for Trolox, a dose-response for CAT or a dose-response combination of the two. We used a competitive assay to measure the efficiency of either Trolox, CAT or a combination of the two to disarm hydrogen peroxide. Catalase or Trolox can degrade hydrogen peroxide to water and oxygen: 2H202 2H2O+O2. The remaining peroxide is quantitated by formation of ABTSox in a coupled reaction with peroxidases (POD) and ABTSred.

Data Evaluation:

For each sample, the remaining peroxide is quantitated by formation of ABTSox, which absorbs at 450 nm. The Absorption at 450 nm is plotted as a function of the enzyme dose, i.e. concentration or activity. A logistic 4 parametric function was used in SAS JMP16 to fit the logistic function to the data. This function was used to calculate the amount of CAT necessary in order to reach the same absorption at 450 nm as for a given Trolox sample in the assay. The slope describes how many grams of Trolox equivalents a mg or Unit of enzyme contains and this was used to calculate the Trolox equivalents for a mg or unit of enzyme.

Conclusion: Comparison of SOD and/or CAT and Trolox

SOD is much more efficiently in disarming superoxide than Trolox. CAT is much more efficiently in disarming hydrogen peroxide than Trolox. In the lumen, SOD and CAT disarm superoxide and hydrogen peroxide and thus protect Trolox and vitamin E. The vitamin can thus be taken up intact systemically and can exert its antioxidant effect when entering into the cell membrane.

### Example 6: Preventing Oxidation of Lipids

Protection of Lipids from Reactive Oxygen Species by Oxydoreductase Enzymes Superoxide Dismutase (SOD) and Catalase (CAT)

In all experiments, the catalase used was SEQ ID NO:6 and the SOD used was SEQ ID NO: 28

ROS can be formed from oxygen as a metabolic/respiratory byproduct or by other factors such as heat, radiation (UV, ionizing), drought, salinity, chilling, defense of pathogens, nutrient deficiency, metal toxicity, toxins, xenobiotics, and pollutants. Fatty acids and lipids like e.g. polyunsaturated fatty acids are susceptible to damage by ROS. When a polyunsaturated fatty acid reacts with an oxygen radical, it forms a lipid radical. This lipid radical can react further to form a peroxyl radical. In a well-defined chain reaction, the peroxyl radical ends up as malondialdehyde (MDA), a fingerprint for lipid oxidation

MDA can get quantified when reacted with thiobarbituric acid (TBA), through absorption and fluorescence of the resulting TBARS product. The strength of the absorption and fluorescence signal is proportional to the MDA present in the sample to be analyzed. We used a kit to quantify lipid peroxidation, where MDA is reacted with (TBA) to form a colorimetric (532 nm)/fluorometric (λₑₓ=532/λₑₘ=553 nm) product, proportional to the MDA present. From a standard curve with a known MDA concentration, the MDA content of the samples is determined.

### Experiment

The effect of hydrogen peroxide and superoxide on the free fatty acid α-linolenic acid (ALA) was tested. Furthermore, whether catalase and superoxide dismutase can protect the free fatty acid α-linolenic acid (ALA) from oxidation/peroxidation by the hydrogen peroxide or superoxide, respectively, was tested.

The following reaction mixtures (pH=8, total volume=500 μl) were prepared and incubated for 2 hours and 24 hours at 30 deg C., before lipid peroxidation was quantified by using a MDA quantification kit:

Samples with low concentration of α-linolenic acid:
i. 0.5 μg/μL α-linolenic acid
ii. 0.5 μg/μL α-linolenic acid+0.145% (w/v) H₂O₂
iii. 0.5 μg/μL α-linolenic acid+0.102 mM hypoxanthine/0.0013 U/mL xanthine oxidase (superoxide generating system)
iv. 0.5 μg/μL α-linolenic acid+0.145% (w/v) H₂O₂+100 U/mL CAT
v. 0.5 μg/μL α-linolenic acid+0.102 mM hypoxanthine/0.0013 U/mL xanthine oxidase (superoxide generating system)+1.818 U/mL SOD
vi. 0.5 μg/μL α-linolenic acid+0.102 mM hypoxanthine/0.0013 U/mL xanthine oxidase (superoxide generating system)+1.818 U/mL SOD+100 U/mL CAT

The results (low concentration of α-linolenic acid) from the MDA quantification determined by the kit are shown in Error! Reference source not found. (the bars follow the sequence i.-vi. and then again repeated i.-vi.)

Samples with high concentration of α-linolenic acid:
i. 5 μg/μL α-linolenic acid
ii. 5 μg/μL α-linolenic acid+0.145% (w/v) H2O2
iii. 5 μg/μL α-linolenic acid+0.102 mM hypoxanthine/0.0013 U/mL xanthine oxidase (superoxide generating system)
iv. 5 μg/μL α-linolenic acid+0.145% (w/v) H2O2+100 U/mL CAT
v. 5 μg/μL α-linolenic acid+0.102 mM hypoxanthine/0.0013 U/mL xanthine oxidase (superoxide generating system)+1.818 U/mL SOD
vi. 5 μg/μL α-linolenic acid+0.102 mM hypoxanthine/0.0013 U/mL xanthine oxidase (superoxide generating system)+1.818 U/mL SOD+100 U/mL CAT

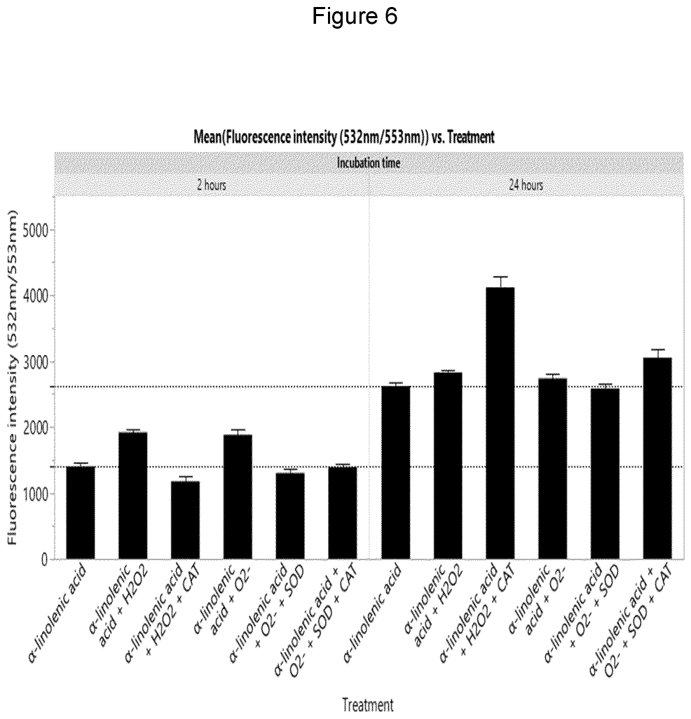

The results (low concentration of α-linolenic acid) from the MDA quantification determined by the kit are shown in FIG. 6. (the bars follow the sequence i.-vi. and then again repeated i.-vi.)

### Conclusions

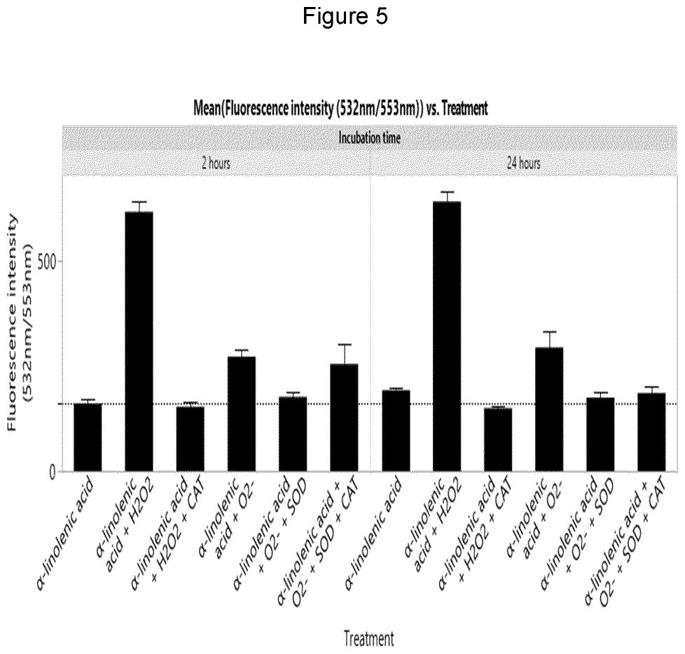

0.5 μg/μL α-linolenic acid and 2 hours reaction (FIG. 5, left side): when α-linolenic acid is incubated in the presence of hydrogen peroxide, the amount of MDA and thus lipid oxidation is increased compared to the α-linolenic acid control. When adding CAT in addition to the hydrogen peroxide, the lipid oxidation is on par or even slightly below the α-linolenic acid control, thus showing good protection by the CAT from hydrogen peroxide. The similar is observed when using superoxide as a stressor (formed through the hypoxantine/xanthine oxidase system). Superoxide leads to more lipid oxidation (and MDA formation) compared to the α-linolenic acid control. When adding SOD on top of the superoxide, α-linolenic acid is protected and MDA levels are approximately on par with the α-linolenic acid control and below the α-linolenic acid+superoxide sample.

0.5 μg/μL α-linolenic acid and 24 hours reaction (FIG. 5, right side): when α-linolenic acid is incubated in the presence of hydrogen peroxide, the amount of MDA and thus lipid oxidation is increased compared to the α-linolenic acid control. When adding CAT in addition to the hydrogen peroxide, the lipid oxidation is even below the α-linolenic acid control, thus showing good protection by the CAT from hydrogen peroxide. The similar is observed when using superoxide as a stressor (formed through the hypoxantine/xanthine oxidase system). It leads to more lipid oxidation (and MDA quantification) compared to the α-linolenic acid control. When adding SOD or SOD&CAT on top of the superoxide, α-linolenic acid is protected and MDA levels are on par/slightly below the α-linolenic acid control.

5 μg/μL α-linolenic acid and 2 hours reaction (FIG. 6, left side): when α-linolenic acid is incubated in the presence of hydrogen peroxide, the amount of MDA and thus lipid oxidation is increased compared to the α-linolenic acid control. When adding CAT in addition to the hydrogen peroxide, the lipid oxidation is even below the α-linolenic acid control, thus showing good protection by the CAT from hydrogen peroxide. The similar is observed when using superoxide as a stressor (formed through the hypoxantine/xanthine oxidase system). It leads to more lipid oxidation (and MDA quantification) compared to the α-linolenic acid control. When adding SOD or SOD&CAT on top of the superoxide, α-linolenic acid is protected and MDA levels are slightly below the α-linolenic acid control.

5 μg/μL α-linolenic acid and 24 hours reaction (FIG. 6, right side): lipid oxidation is much higher compared to 2 hour incubation. Also, hydrogen peroxide and superoxide addition is hardly affecting the amount of fluorescence and hence lipid oxidation.

### Example 7—Preventing Oxidation of Proteins

7. 1 Protection of rHSA from Superoxide and Hydrogen Peroxide.

### Experiment

Six samples were made, each with a final rHSA concentration of 1 mg/ml. The composition of the samples is listed below. All samples were incubated for 60 minutes.
1. Sample 1 (T1.3) serves as a control for unmodified rHSA.
2. Sample 2 (T2.3) contains rHSA and the ROS hydrogen peroxide (0.01% (w/v))
3. Sample 3 (T3.3) contains rHSA, the ROS hydrogen peroxide (0.01% (w/v)) and 100 U/mL catalase
4. Sample 4 (T4.3) contains rHSA, and the ROS superoxide generated by xanthine oxidase (0.0014 U/mL) from hypoxanthine (0.112 mM)
5. Sample 5 (T5.3) contains rHSA, the ROS superoxide generated by xanthine oxidase (0.0014 U/mL) from hypoxanthine (0.112 mM) and 10 U/mL superoxide dismutase.
6. Sample 6 (T6.3) contains rHSA, the ROS superoxide generated by xanthine oxidase (0.0014 U/mL) from hypoxanthine (0.112 mM), 10 U/mL superoxide dismutase and 100 U/mL catalase

### Conclusions

rHSA is modified by hydrogen peroxide (+78 Da). rHSA is further modified by superoxide (+43 Da) generated by the xanthine oxidase from hypoxanthine. Superoxide dismutase prevents this 43-dalton superoxide modification of rHSA

### 7.2 Protection of Catalase

Granules comprising catalase alone, superoxide dismutase alone, and combinations thereof were prepared as described in U.S. Pat. No. 4,106,991, example 1. The catalase used is the polypeptide from Thermoascus aurantiacus having catalase activity sold under the tradename Terminox™ (SEQ ID NO:6).

### Catalase Granulates

A powder mixture with the following composition
1200 g Cellulose, Arbocel BC200
1200 g Kaolin
11693 g ground Na₂SO₄
was granulated in a Lödige mixer FM 50 with a granulation fluid consisting of
900 g Sucrose
14 g Catalase concentrate
1942 g water

The granulated was dried in a fluid bed dryer to a water content of less than 1% and sifted to obtain a product with the particle size between 250 and 850 micrometers.

### Granules Comprising Superoxide Dismutase

A powder mixture with the following composition
960 g cellulose, Arbocel BC200
1540 g dextrin, kaolin
8867 g ground Na2SO4
was granulated in a Lödige mixer FM 50 with a granulation fluid consisting of
480 g Dextrin
1331 g Superoxide dismutase concentrate containing the polypeptide of SEQ ID No: 1
242 g water

The granulated was dried in a fluid bed dryer to a water content of less than 1% and sifted to obtain a product with the particle size between 250 and 1200 micrometers.

### Catalase and Superoxide Dismutase Co-Granule

A powder mixture with the following composition
960 g cellulose, Arbocel BC200
960 g kaolin
957 g Spray dried superoxide dismutase
8036 g ground Na2SO4
was granulated in a Lödige mixer FM 50 with a granulation fluid consisting of
720 g Dextrin
1926 g Superoxide dismutase concentrate containing the polypeptide of SEQ ID No: 1
3 g Catalase concentrate containing the polypeptide of SEQ ID No: 6

The granulated was dried in a fluid bed dryer to a water content of less than 1% and sifted to obtain a product with the particle size between 250 and 1200 micrometers.

The granules were subjected to a laboratory scale steaming box, where they were exposed to a temperature of 95° C. and 95% relative humidity, for a conditioning time of 90 sec.

The Example illustrates that even catalases of the invention, provides the stabilizing effect on the catalase. The example was performed with the SODs of the invention and demonstrated high stabilizing effect on catalases.

| | | CAT | SOD |
|---|---|---|---|
| | | Stability | Stability |
| Granule | Formulation | (activity %) | (activity %) |
| Catalase of SEQ ID | Cellulose/Dextrin/ | 2% | — |
| NO: 6 | Kaolin/Na₂SO₄ | | |
| SOD of SEQ ID | Cellulose/Dextrin/ | — | (16%) |
| NO: 28 | Kaolin/Na₂SO₄ | | |
| SEQ ID NO: 6 + | Cellulose/Dextrin/ | 63% | (22%) |
| SEQ ID NO: 28 | Kaolin/Na₂SO₄ | | |

### Example 8—SOD and Catalase to Prevent Oxidation of Mammalian Cells

### 8.1: In Vitro Cell-Based Systems to Generate Reactive Oxygen Species and Neutralization by Oxidoreductase Enzyme Superoxide Dismutase (SOD).

Cell Lines:
1) HD11/k7 (chicken macrophage like cells, note include NFKB-Luc Reporter),
2) IPECJ2 (swine intestinal epithelial cells)

Superoxide Generation:
1) PMA (Phorbol 12-myristate 13-acetate), PKC activator generating superoxide via NADPH Oxidase.
2) HX+XO: Extracellular addition of hypoxanthine(HX) and xanthine oxidase.
Superoxide monitoring: WST1 reduction, increased A450 reading
SOD: HEAL-7057-6
Experiment 1 (ELN-21-LNHS-105):

HD11/k7 chicken macrophage cells were exposed to the indicated dosage of PMA to generate ROS. The SOD was added and the levels of ROS monitored by extracellular reduction of WST-1.

Generation of superoxide measured by reduction of WST1 leading to increased absorbance at 450 nm:
1. Seed cells were placed in well plates overnight and subjected to PMA treatment to generate superoxide.
2. Re-seed of the cells in 96 wells with and without SOD in HBSS with WST-1 (PMA withdrawn).
3. OD is every 20 minutes for 8 hours.

Conclusions: PMA generated superoxide is neutralized by SOD reducing the oxidation extent of the cells.

8-12: IPECJ2 Cells Cultured as Confluent Monolayer were Exposed to Superoxide Generated by Addition of Hypoxanthine (1 mM) and Increasing Units of Xanthine Oxidase. SOD was Added at 8U/Ml

Scheme of Experimental Overview.
1. IPEC-J2 cells were seeded in 96 wells for 4 days (monolayer)
2. The cells were treated with HX and XO and WST-1
3. OD was measured for 4 hours

Conclusions: HX+XO system can generated superoxide over IPECJ2 cells. Generation of superoxide increases with increasing levels of XO. This impairs the cells. This impairment is reduced by SOD.

8.3 Protection of IPEC-J2 Cells from Harmful Effect of the Reactive Oxygen Species Hydrogen Peroxide by Catalase (CAT, HEAL-7009-4) Exposure of IPECJ2 Cells to 2 mM H₂O₂ and Increasing Units of Catalase.

Scheme of Experimental Overview.
4. IPEC-J2 cells were seeded in 96 wells for 4 days (monolayer)
5. The cells were treated with catalase first, then hydrogen peroxide
6. OD was measured for 8 hours

Conclusions: Exposure to H₂O₂ leads to a rapid loss of monolayer confluency that can be protected by incubation with catalase.

From the result it can be concluded that the presence of SOD stabilize the catalase during the heat and humidity treatment. The catalase used is the polypeptide from Thermoascus aurantiacus having catalase activity sold under the tradename Terminox™ (SEQ ID NO:6).

1-33. (canceled)

34. A composition comprising an enzymatic preservative in an amount sufficient to inhibit degradation of one or more vitamins, one or more proteins, one or more fats and/or one or more lipids when said composition is introduced into a feed or feed additive comprising said one or more vitamins, one or more proteins, one or more fats and/or one or more lipids,
said enzymatic preservative comprising a polypeptide having catalase activity and/or a polypeptide having superoxide dismutase activity.

35. The composition of claim 34, said enzymatic preservative comprising a polypeptide having catalase activity.

36. The composition of claim 35, said polypeptide having catalase activity selected from the group consisting of catalases belonging to EC 1.11.1.6 and catalases belonging to EC 1.11.1.21.

37. The composition of claim 35, said polypeptide having catalase activity being of fungal origin.

38. The composition of claim 35, said polypeptide having catalase activity selected from the group consisting of:
polypeptides having at least 80% identity to SEQ ID NO: 1;
polypeptides having at least 80% identity to SEQ ID NO: 2;
polypeptides having at least 80% identity to SEQ ID NO: 3;
polypeptides having at least 80% identity to SEQ ID NO: 4;
polypeptides having at least 80% identity to SEQ ID NO: 5;
polypeptides having at least 80% identity to SEQ ID NO: 6;
polypeptides having at least 80% identity to SEQ ID NO: 7;
polypeptides having at least 80% identity to SEQ ID NO: 8;
polypeptides having at least 80% identity to SEQ ID NO: 9;
polypeptides having at least 80% identity to SEQ ID NO: 10;
polypeptides having at least 80% identity to SEQ ID NO: 11;
polypeptides having at least 80% identity to SEQ ID NO: 12;
polypeptides having at least 80% identity to SEQ ID NO: 13;
polypeptides having at least 80% identity to SEQ ID NO: 14;
polypeptides having at least 80% identity to SEQ ID NO: 15;
polypeptides having at least 80% identity to SEQ ID NO: 16;
polypeptides having at least 80% identity to SEQ ID NO: 17;
polypeptides having at least 80% identity to SEQ ID NO: 18;
polypeptides having at least 80% identity to SEQ ID NO: 19;
polypeptides having at least 80% identity to SEQ ID NO: 20;
polypeptides having at least 80% identity to SEQ ID NO: 21;
polypeptides having at least 80% identity to SEQ ID NO: 22;
polypeptides having at least 80% identity to SEQ ID NO: 23;
polypeptides having at least 80% identity to SEQ ID NO: 24;
polypeptides having at least 80% identity to SEQ ID NO: 25;
polypeptides having at least 80% identity to SEQ ID NO: 26; and
polypeptides having at least 80% identity to SEQ ID NO: 27.

39. The composition of claim 34, said enzymatic preservative comprising a polypeptide having superoxide dismutase activity.

40. The composition of claim 39, said polypeptide having superoxide dismutase activity being of fungal origin.

41. The composition of claim 39, said polypeptide having superoxide dismutase activity selected from the group consisting of:
polypeptides having at least 80% identity to SEQ ID NO: 28;
polypeptides having at least 80% identity to SEQ ID NO: 29;
polypeptides having at least 80% identity to SEQ ID NO: 30; and
polypeptides having at least 80% identity to SEQ ID NO: 31.

42. The composition of claim 34, said enzymatic preservative comprising a polypeptide having catalase activity and a polypeptide having superoxide dismutase activity.

43. The composition of claim 42, said polypeptide having catalase activity selected from the group consisting of catalases belonging to EC 1.11.1.6 and catalases belonging to EC 1.11.1.21.

44. The composition of claim 42, said polypeptide having catalase activity being of fungal origin.

45. The composition of claim 42, said polypeptide having catalase activity selected from the group consisting of:
polypeptides having at least 80% identity to SEQ ID NO: 1;
polypeptides having at least 80% identity to SEQ ID NO: 2;
polypeptides having at least 80% identity to SEQ ID NO: 3;
polypeptides having at least 80% identity to SEQ ID NO: 4;
polypeptides having at least 80% identity to SEQ ID NO: 5;
polypeptides having at least 80% identity to SEQ ID NO: 6;
polypeptides having at least 80% identity to SEQ ID NO: 7;
polypeptides having at least 80% identity to SEQ ID NO: 8;
polypeptides having at least 80% identity to SEQ ID NO: 9;
polypeptides having at least 80% identity to SEQ ID NO: 10;
polypeptides having at least 80% identity to SEQ ID NO: 11;
polypeptides having at least 80% identity to SEQ ID NO: 12;
polypeptides having at least 80% identity to SEQ ID NO: 13;
polypeptides having at least 80% identity to SEQ ID NO: 14;
polypeptides having at least 80% identity to SEQ ID NO: 15;
polypeptides having at least 80% identity to SEQ ID NO: 16;
polypeptides having at least 80% identity to SEQ ID NO: 17;
polypeptides having at least 80% identity to SEQ ID NO: 18;
polypeptides having at least 80% identity to SEQ ID NO: 19;
polypeptides having at least 80% identity to SEQ ID NO: 20;
polypeptides having at least 80% identity to SEQ ID NO: 21;
polypeptides having at least 80% identity to SEQ ID NO: 22;
polypeptides having at least 80% identity to SEQ ID NO: 23;
polypeptides having at least 80% identity to SEQ ID NO: 24;
polypeptides having at least 80% identity to SEQ ID NO: 25;
polypeptides having at least 80% identity to SEQ ID NO: 26; and
polypeptides having at least 80% identity to SEQ ID NO: 27.

46. The composition of claim 42, said enzymatic preservative comprising a polypeptide having superoxide dismutase activity.

47. The composition of claim 42, said polypeptide having superoxide dismutase activity being of fungal origin.

48. The composition of claim 42, said polypeptide having superoxide dismutase activity selected from the group consisting of:
polypeptides having at least 80% identity to SEQ ID NO: 28;
polypeptides having at least 80% identity to SEQ ID NO: 29;
polypeptides having at least 80% identity to SEQ ID NO: 30; and
polypeptides having at least 80% identity to SEQ ID NO: 31.

49. The composition of claim 42, said polypeptide having catalase activity selected from the group consisting of:
polypeptides having at least 80% identity to SEQ ID NO: 1;
polypeptides having at least 80% identity to SEQ ID NO: 2;
polypeptides having at least 80% identity to SEQ ID NO: 3;
polypeptides having at least 80% identity to SEQ ID NO: 4;
polypeptides having at least 80% identity to SEQ ID NO: 5;
polypeptides having at least 80% identity to SEQ ID NO: 6;
polypeptides having at least 80% identity to SEQ ID NO: 7;
polypeptides having at least 80% identity to SEQ ID NO: 8;
polypeptides having at least 80% identity to SEQ ID NO: 9;
polypeptides having at least 80% identity to SEQ ID NO: 10;
polypeptides having at least 80% identity to SEQ ID NO: 11;
polypeptides having at least 80% identity to SEQ ID NO: 12;
polypeptides having at least 80% identity to SEQ ID NO: 13;
polypeptides having at least 80% identity to SEQ ID NO: 14;
polypeptides having at least 80% identity to SEQ ID NO: 15;
polypeptides having at least 80% identity to SEQ ID NO: 16;
polypeptides having at least 80% identity to SEQ ID NO: 17;
polypeptides having at least 80% identity to SEQ ID NO: 18;
polypeptides having at least 80% identity to SEQ ID NO: 19;
polypeptides having at least 80% identity to SEQ ID NO: 20;
polypeptides having at least 80% identity to SEQ ID NO: 21;
polypeptides having at least 80% identity to SEQ ID NO: 22;
polypeptides having at least 80% identity to SEQ ID NO: 23;
polypeptides having at least 80% identity to SEQ ID NO: 24;
polypeptides having at least 80% identity to SEQ ID NO: 25;
polypeptides having at least 80% identity to SEQ ID NO: 26; and
polypeptides having at least 80% identity to SEQ ID NO: 27, and
said polypeptide having superoxide dismutase activity selected from the group consisting of:
polypeptides having at least 80% identity to SEQ ID NO: 28;
polypeptides having at least 80% identity to SEQ ID NO: 29;
polypeptides having at least 80% identity to SEQ ID NO: 30; and
polypeptides having at least 80% identity to SEQ ID NO: 31.

50. A method comprising introducing an enzymatic preservative into a composition in an amount sufficient to inhibit degradation of one or more vitamins, one or more proteins, one or more fats and/or one or more lipids in said composition,
said enzymatic preservative comprising a polypeptide having catalase activity and/or a polypeptide having superoxide dismutase activity.

51. A method comprising applying the composition of claim 34 to an animal feed or animal feed additive.

52. An animal feed comprising the composition of claim 34.

53. An animal feed additive comprising the composition of claim 34.
